(19) United States
(12) Patent Application Publication
(10) Pub. No.: US 2010/0153156 A1
(43) Pub. Date: Jun. 17, 2010

(54) Critically/vulnerability/risk logic analysis methodology for business enterprise and cyber security

(76) Inventors: Lawrence R. Guinta, Scottsdale, AZ (US); Lori A. Frantzve, Scottsdale, AZ (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/792,983

(22) PCT Filed: Dec. 13, 2005
(86) PCT No.: PCT/US05/45172

§ 371 Date: Feb. 22, 2010

Related U.S. Application Data
(60) Provisional application No. 60/635,705, filed on Dec. 13, 2004.

(51) Int. Cl. G06Q 10/00; G06N 5/02

(52) U.S. Cl. 705/8; 706/54

(57) ABSTRACT

Method and apparatus for computer-aided assessment of risk, criticality, and vulnerability with respect to a site. The method and apparatus may use multiple factors to determine overall risk. In some embodiments, the method may assess or determine an impact if a site or asset is lost. The method and apparatus may identify and quantify what risks are acceptable and unacceptable. In an embodiment, a method and apparatus may incorporate mathematical evaluations and numeric assignments that result in a criticality vector and a vulnerability vector. In some embodiments, the criticality vector and vulnerability vector may be used to represent a site's overall risk and/or prioritization and ranking relative to other sites.

### BACKGROUND OF ME INVENTION

1. Field of the Invention

The invention relates to computer-aided methods and apparatuses for assessing the criticality, vulnerability, and overall associated risk of an organization, its system or processes.

2. Description of the Relevant Art

Since September 11, the United States Government and its associated agencies, such as the Department of Defense (DoD), the Department of Homeland Security (DHS), etc., have an increased need to assess and determine the criticality, vulnerability, and overall risk relating to key sites located throughout the world. These sites are often referred to as “facilities” or “assets.” Individual states and their associated agencies, such as an individual state's Department of Homeland Security (DHS), as well as private entities, have a similarly increased need for such assessments and determinations. Thus, a great many organizations are now challenged with the problem of determining its criticality, vulnerability, and overall risk as it relates to region, state, and nation. Large corporations, professional associations, and government units often perform organizational assessments, both within their own organizations and those of third parties, such as corporate divisions, subsidiaries, departments, and third party providers. The assessments can cover a wide range of topics, often relating to such matters as safety, efficiency, cost control, and reliability. Conventionally, such evaluations have been conducted in conjunction with on-site audits and inspections. Such audits and inspections, however, tend to be burdensome, expensive, and time consuming for both the assessing and audited entities.

To reduce the burdens associated with these evaluations, surveys are commonly employed to gather information concerning organizational processes or systems. A problem with surveys, however, is that validation of the accuracy and truthfulness of answers received is often difficult and expensive, especially when responses are prepared by potentially biased persons, such as suppliers of goods and services.

Another problem with conventional survey techniques is associated with generating an optimal structure for the survey. For example, a useful data gathering technique called “conditional response” involves presenting an assessor a question, and, based on the answer to the question, branching to one or more subsequent questions. Each subsequent question may then also branch to further subsequent questions based on answers provided. In this manner, a complicated “tree” of questions and answers may be prepared. One problem with the conditional response technique, however, is that the assessment criteria that direct the branching are highly subjective. Thus, the person developing the criteria may bias the survey. Furthermore, preparing or revising a conditional response survey tends to be difficult and expensive since the “tree” is highly structured, thus making preparation of the tree, or revisions to the tree, complicated, time consuming and cumbersome. For instance, if an early question in the tree is changed, then a whole series of subsequent “branching” questions may also have to be changed.

Another problem with the conditional response technique is that available answers tend to be absolute in nature. For example, responses to the questions typically demand a “yes” or a “no”, with no option for a qualified response. It is often useful, however, to use other types of questions demanding non-absolute responses. For example, a survey may call for responses such as numerical responses, multiple-choice responses, arbitrary textual responses, or multiple choices from a number of selections (e.g. “check all that apply”). Although these non-absolute responses are often useful, adapting them to the conditional response technique often proves complicated and cumbersome.

### SUMMARY OF THE INVENTION

A method and apparatus may use a computer to gather information to measure and determine the criticality, vulnerability, and associated overall risk with respect to a site, facility, or asset. The method and apparatus may use multiple factors to determine overall risk. In some embodiments, the method may assess or determine an impact if a site or asset is lost. In an embodiment, the method and apparatus may identify and quantify what risks are acceptable and unacceptable. In some embodiments, the method and apparatus may determine the type and extent of countermeasures required to reduce unacceptable risks to an acceptable level.

In an embodiment, a method and apparatus may incorporate mathematical evaluations and numeric assignments that result in a criticality vector and a vulnerability vector. In some embodiments, the criticality vector and vulnerability vector may be used to represent a site's overall risk and/or prioritization and ranking relative to other sites.

In an embodiment, a method of assessing risk for a customer includes receiving a list of at least two sites (e.g., defense industrial base sites) from a customer and storing the list of sites in a memory of a computer system. The sites may be provided with remote access to the computer system. The sites may provide risk assessment data via remote access. A risk assessment is automatically performed using the risk assessment data. The customer is provided with the risk assessment. In some embodiments, the risk assessment includes an assessment of criticality and/or vulnerability for the sites. In certain embodiments, a risk assessment includes an assessment of cyber security for a business enterprise. In some embodiments, a customer accesses the risk assessment remotely through a viewing utility. In one embodiment, a customer accesses risk assessment data through a terrorist view.

In some embodiments, receiving risk assessment from sites includes managing one or more events. Each event may include receiving risk assessment data the sites within a scheduled time period. In certain embodiments, sites are grouped into blocks. An event may be scheduled for each of a plurality of levels of assessment within a block.

### BRIEF DESCRIPTION OF THE DRAWINGS

Other objects and advantages of the invention will become apparent upon reading the following detailed description and upon reference to the accompanying drawings in which:

FIG. 1 depicts an apparatus including a computer, a display device, and an input device;

FIG. 2 depicts a general chart of an assessment process according to various aspects of the present invention;

FIG. 3 depicts a general chart of an exemplary assessment initiation system;

FIG. 4 depicts a flow-chart wherein an assessor is prompted to input a numerical input reflective of how well a system addresses an issue;

FIG. 5 depicts a flow-chart wherein an assessor is prompted to input a numerical input reflective of how extensively a system is deployed;

FIG. 6 depicts a flow chart wherein an assessor is prompted to input a numerical input reflective of results achieved by the system;

FIGS. 7A-7E depict a series of “sliding bar” displays;

FIG. 8 depicts a flow chart for a corrective action system;

FIG. 9 depicts a schematic view of an embodiment of a personal digital assistant;

FIGS. 10A-C depict a series of “double sliding bar” displays;

FIG. 11 depicts a flow chart of a process for using a computer to assess risk;

FIG. 12 depicts a block diagram including a system for assessing risk at customer sites;

FIG. 13 depicts a flow chart of a process for assessing risk at customer sites.

While the invention is susceptible to various modifications and alternative forms, specific embodiments thereof are shown by way of example in the drawing and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF PREFERRED EMBODIMENTS

Embodiments presented herein may be particularly suited for use in connection with methods and apparatus suited for assessing and determining a criticality, vulnerability, and associated overall risk with respect to a site, facility, or asset. In addition, certain embodiments presented herein may be suited for assessing an organizational process or system, such as computer-aided systems for measuring, evaluating, and gathering information about organizational processes and systems. As a result, the embodiments are described in those contexts. It should be recognized, however, that the description is not intended as a limitation on the use or applicability of the present invention, but is instead provided merely to enable a full and complete description of the embodiments.

The following non-exclusive definitions may apply to embodiments described herein:

| Term | Definition |
|---|---|
| Asset | Includes, but is not limited to, an identified physical, network, or |
| | service entity that is vital to operations and its ability to fulfill a |
| | mission. |
| Site | Includes, but is not limited to, a physical address (i.e. 123 Main |
| | Street, Hometown, USA). |
| Event | Includes, but is not limited to, a scheduled assessment |
| | administered to one or more sites with a definitive beginning and |
| | end (i.e. 30 day event). |
| E- | Includes, but is not limited to, an electronic certification process |
| Ticket | that enables a designated site to access an administrative |
| | organization's system and participate a single time in an |
| | assessment event. |
| Threat | Includes, but is not limited to, a person, event or thing having |
| | the intent or capability to cause extreme loss or damage to a |
| | soft or hard target. |
| Vulner- | Includes, but is not limited to, a site's susceptibility to attack |
| ability | resulting in potential injury or loss of human life, a place or a |
| | thing. |
| Criti- | Includes, but is not limited to, the importance of an asset relative |
| cality | to its mission and the associated dependency on the process or |
| | another asset. |

The term “computer system” as used herein generally describes the hardware and software components that in combination allow the execution of computer programs. The computer programs may be implemented in software, hardware, or a combination of software and hardware. A computer system's hardware generally includes a processor, memory media, and input/output (I/O) devices. As used herein, the term “processor” generally describes the logic circuitry that responds to and processes the basic instructions that operate a computer system. The term “memory medium” includes an installation medium, e.g., a CD-ROM, floppy disks; a volatile computer system memory such as DRAM, SRAM, EDO RAM, Rambus RAM, etc.; or a non-volatile memory such as optical storage or a magnetic medium, e.g., a hard drive. The term “memory' is used synonymously with “memory medium” herein. The memory medium may comprise other types of memory or combinations thereof. In addition, the memory medium may be located in a first computer in which the programs are executed, or may be located in a second computer that connects to the first computer over a network. In the latter instance, the second computer provides the program instructions to the first computer for execution. In addition, the computer system may take various forms, including a personal computer system, mainframe computer system, workstation, network appliance, Internet appliance, personal digital assistant (PDA), television system or other device. In general, the term “computer system” can be broadly defined to encompass any device having a processor that executes instructions from a memory medium.

The memory medium preferably stores a software program or programs for the reception, storage, analysis, and transmittal of information produced by an Analyte Detection Device (ADD). The software program(s) may be implemented in any of various ways, including procedure-based techniques, component-based techniques, and/or object-oriented techniques, among others. For example, the software program may be implemented using ActiveX controls, C++ objects, JavaBeans, Microsoft Foundation Classes (MFC), or other technologies or methodologies, as desired. A CPU, such as the host CPU, for executing code and data from the memory medium includes a means for creating and executing the software program or programs according to the methods, flowcharts, and/or block diagrams described below.

A computer system's software generally includes at least one operating system such as Windows NT, Windows 95, Windows 98, or Windows ME, Windows 2000, Windows XP all available from Microsoft Corporation, a specialized software program that manages and provides services to other software programs on the computer system. Software may also include one or more programs to perform various tasks on the computer system and various forms of data to be used by the operating system or other programs on the computer system. The data may include but is not limited to databases, text files, and graphics files. A computer system's software generally is stored in non-volatile memory or on an installation medium. A program may be copied into a volatile memory when running on the computer system. Data may be read into volatile memory as the data is required by a program.

A server program may be defined as a computer program that, when executed, provides services to other computer programs executing in the same or other computer systems. The computer system on which a server program is executing may be referred to as a server, though it may contain a number of server and client programs. In the client/server model, a server program awaits and fulfills requests from client programs in the same or other computer systems. An example of a computer program that may serve as a server is Windows NT server or Window Small Business Server, available from Microsoft Corporation.

A web server is a computer system which maintains a web site browsable by any of various web browser software programs. As used herein, the term “web browser” refers to any software program operable to access web sites over a computer network.

An intranet is a network of networks that is contained within an enterprise. An intranet may include many interlinked local area networks (LANs) and may use data connections to connect LANs in a wide area network (WAN). An intranet may also include connections to the Internet. An intranet may use TCP/IP, HTTP, and other Internet protocols.

An extranet is a private network that uses the Internet protocols and the public telecommunication system to securely share part of a business' information or operations with suppliers, vendors, partners, customers, or other businesses. An extranet may be viewed as part of a company's intranet that is extended to users outside the company. An extranet may require security and privacy. Companies may use an extranet to exchange large volumes of data, share product catalogs exclusively with customers, collaborate with other companies on joint development efforts, provide or access services provided by one company to a group of other companies, and to share news of common interest exclusively with partner companies.

Connection mechanisms included in a network may include copper lines, optical fiber, radio transmission, satellite relays, or any other device or mechanism operable to allow computer systems to communicate.

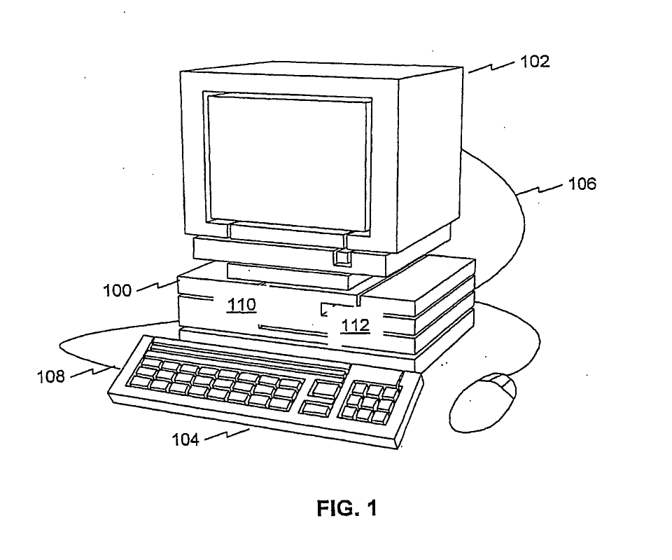

Referring now to FIG. 1, a computer system suitable for implementing an organizational assessment system according to various aspects of the present invention may include a conventional desktop personal computer system 100. The computer 100 may be configured in any suitable manner to implement various aspects of the present invention. For example, the computer 100 may include a memory 110 and a processing unit 112. The computer 100 may be further adapted, using any suitable computer software or hardware, to perform the various functions as described herein. For example, the computer may comprise an IBM or Apple compatible computer, such as a Sytech 486166 or a Dell 433SINP. Alternatively, the computer 100 comprises any appropriate computer system, such as a mainframe computer, a minicomputer, or a network server.

Computer 100 may include various interfaces to operate in conjunction with an assessor. For example, computer 100 may be coupled via a line 106 to a display device 102, such as a computer screen like a Sony Multiscan 17se or a HP L1702 Flat Panel Monitor computer screen. The display device may be viewed by an assessor while interacting with the organizational assessment system. Computer 100 may also be coupled via a second line 108 to an input device 104 to facilitate the submission of information by the human assessor. The input device 104 of the computer may be a keyboard, a mouse, or a touch screen. In some instances, the input device 104 may include a speech recognition device that converts spoken words into machine-readable inputs. Additional or substitute input and output devices, such as modems, printers, speakers, voice recognition circuitry, or any other suitable input or output device may be connected to computer 100 to facilitate communication with the human assessor or another computer system.

Computer 100 is configured to execute computer programs for assessing an organizational process or system. The computer when operating the computer programs may perform operations such as displaying questions, receiving and storing responses, comparing responses to various values, and preparing reports. An “assessor” may be defined as a person or system which interacts with the computer and the computer program, for example in conjunction with a series of computer-driven questions. The assessor may have at least some knowledge about the organizational process or system. At least some of the computer-driven questions may be adapted to prompt an assessor to submit via input device 104 a response relating to the capability of the organizational process or system to address an issue.

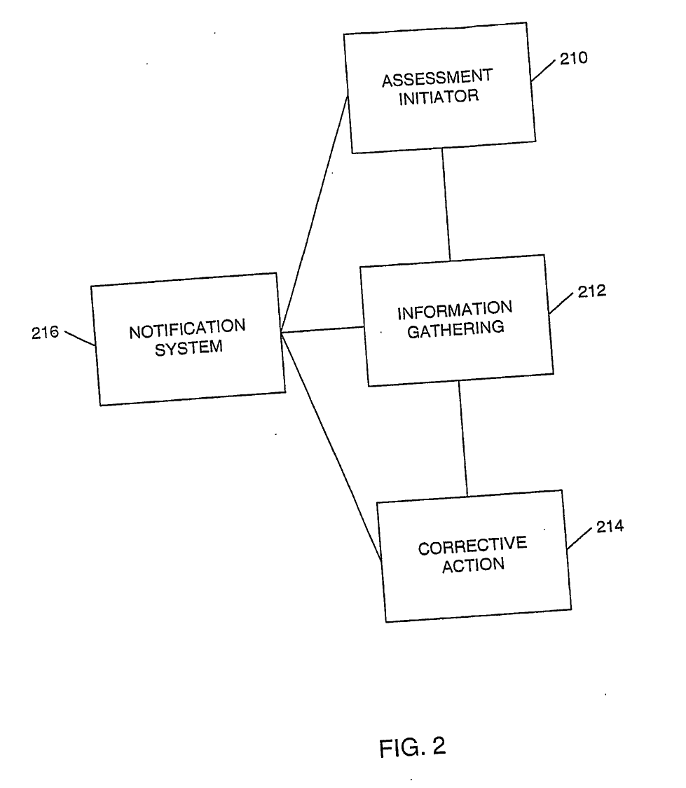

For example, referring now to FIG. 2, in accordance with an exemplary embodiment of an organizational assessment system, a suitable organizational assessment system may include: an assessment initiator system 210; an information gathering system 212; a corrective action system 214; and a notification system 216. Assessment initiator system 210 may interact with an assessment initiator. The “assessment initiator” may be a person initiating the organizational process or system assessment. The initiator may be required to go through multiple security methods to ensure security in user access and privacy of information. Security methods may include, but are not limited to use of certificates, cookies, secure socket layers, virtual private networks, firewalls, etc. For example, the assessment initiator may be a company president or senior officer. Assessment initiator system 210 may, for example, identify personnel to act as assessors for the information gathering system 212. Assessment initiator system 210 may also identify subject matter to be assessed. Assessment initiator system 210 may also gather general organizational characteristics. Information gathering system 212 may then be implemented to accumulate information relating to the relevant processes or systems. Information gathering system 212 may be implemented subsequent to the implementation of assessment initiator system 210. The results obtained and/or generated by assessment initiator system 210 may be used to determine the appropriate implementation of information gathering system 212. The corrective action system 214 may be initiated to identify significant problems and potential solutions. Corrective action system 214 may be implemented subsequent to the implementation of information gathering system 212. The results obtained and/or generated by information gathering system 212, and/or assessment initiator system 210 may be used to determine the appropriate implementation of corrective action system 214. The notification system 216 may be initiated prior to the other systems, and may establish and track an assessment timeline. Notification system 216 may be configured to make notifications to appropriate personnel, for example personnel identified in assessment initiator system 210, regarding the assessment timeline. Although each of these systems suitably operates in conjunction with the others, each of the systems may be configured to operate independently or with less than all of the other systems or features. Further, each of these systems may operate on the same or different computers 100 and may interact with the same or different human assessors.

Assessment initiator system 210 may be configured to identify knowledgeable personnel. Assessment initiator system 210 may be configured to acquire general organizational information. Assessment initiator system 210 may also be configured to perform other functions for facilitating the organizational assessment and the proper performance of information gathering system 212, the corrective action system 214 or the notification system 216. In an embodiment, assessment initiator system 210 may read a series of questions from memory 110 in the computer 100 and provide them to a primary human assessor via display device 102. The questions may be formatted as a single series of questions or provided in any other suitable format, such as in a conditional response format. The primary human assessor may be a person with broad knowledge relating to the organization to be assessed, such as a company president or the head of a division. Assessment initiator system 210 may also operate in conjunction with multiple human assessors, each providing independent responses and information to the questions posed by assessment initiator system 210.

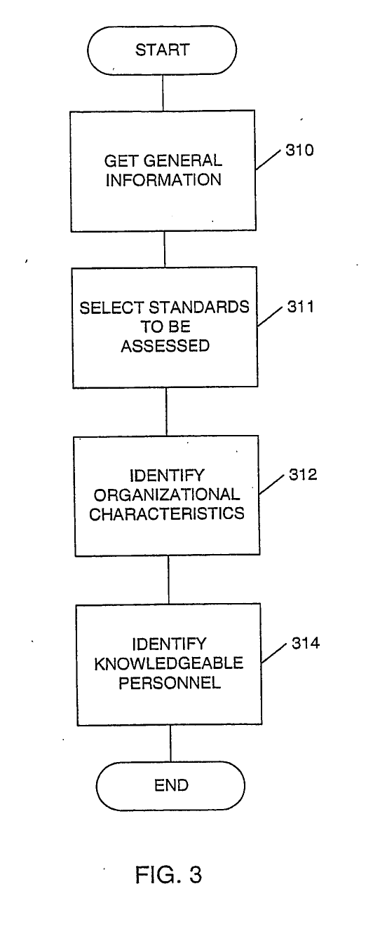

FIG. 3 shows a flow chart for assessment initiator system 210. Assessment initiator system 210 suitably performs multiple process steps. For example, the assessment initiator system may initially request general information about the organization (step 310). Such general information might include, but is not limited to, the organization's name, address, type, size, character of its business.

The organizational assessment system preferably includes a plurality of questions directed the requirements of recognized standards. Recognized standards may include national and international standards as well as industry specific standards. The standards may prescribe system or process criteria regarding quality, leadership, cost, delivery, customer satisfaction, manufacturing technology, tool development, and/or environmental, heath and safety concerns. Such standards may include, but are not limited to: ISO 9000, AS 9000, QS 9000, ISO 14000, ASQC, Lean Manufacturing, Six Sigma, etc. The operational assessment system may also include questions directed to financial, and other business concerns, or other topics. For example, Table 1 contains a list of topics that may be presented. The assessment initiator system may request information concerning which standard (or standards) are to be used when evaluating an organizational process or system (step 311).

The assessment initiator system may further request information regarding the characteristics and capabilities of the relevant organization (step 312). For example, the human assessor may be asked questions such as whether the organization has a manufacturing department, a legal department, an accounting department, or the like. Data acquired by the assessment initiator system relating to the organizational characteristics may be useful for identifying general issues and selecting particular groups of questions to be presented by the assessment initiator system, the information gathering system, and the corrective action system.

Upon entry of such information by the human assessor, the assessment initiator system suitably generates at least one question configured to identify personnel with substantive knowledge of specific subjects pertinent to the assessment (step 314). Such personnel may include, for example, high-ranking employees, supervisors, board members, officers or the like. For example, a first question may request the name and office location of the director of purchasing, and a second question may ask for similar information for the director of human resources. Any number of questions may be posed to identify any number of persons or departments likely to possess relevant information. The nature of these questions may be adjusted according to previous information submitted by the human assessor. For example, if the human assessor previously indicated that the organization has no computer system, questions for identifying the director of computer systems may be omitted. Similarly, if the human assessor indicated that the organization has a legal department, the assessment initiator system 210 may request further information, such as names and office locations for the general counsel, chief patent counsel, and chief litigation counsel.

Notification system 216 may generate an assessment timeline based on information gathered by assessment initiator system 210. Notification system 216 may be configured to export timeline data for use in another software application. For example, notification system 216 may export timeline data which is formatted for use with project management type software application. Exporting timeline data may allow an organization to generate a graph, chart, or other visual summary depicting the timeline. For example, a Gant chart may be generate from the timeline data. In addition, notification system 216 may be configured to merge data gathered by assessment initiator system 210, information gathering system 212, or corrective action system 214 with the timeline data. For instance, general organization information such as address, contacts, etc. may be merged with timeline data for export. Notification system 216 may then initiate information gathering system 212 by notifying appropriate individuals identified by assessment initiator system 210 that the individuals have been selected as assessors to gather specific information relating to the relevant organization within the assessment timeline. Notification system 216 may request acknowledgement of notification and may escalate notification if an acknowledgement is not received in a timely manner. For example, notification system 216 may request that a first individual, identified assessor in assessment initiator system 210, acknowledge receipt of the notification within a predetermined first time period. If receipt of notification is not received by notification system 216 within a predetermined first period of time, notification system 216 may issue a second notification to the assessor. The second notification may include a request to respond with a notification of receipt within a predetermined second time period. If notification of receipt is not received by notification system 216 within the second time period the notification system may escalate the notification. For instance, notification system 216 may notify a second individual of the assessment timeline. Notification system 216 may further notify the second individual that the first individual has not acknowledged receipt of notification within a predetermined time period. The second individual may be an alternate assessor identified in assessment initiator system 210. Alternately, the second individual may be a supervisor, manager, or other organization official empowered to direct the first individual to acknowledge receipt of the notifications, or to select a different assessor instead of the first individual.

In an embodiment, information gathering system 212 may operate in conjunction with a database of questions stored in the memory 110 of the computer 100 to generate at least a portion of a set of questions to be provided to a human assessor. Questions stored within memory 110 may be identified as directed to various standards which may be assessed by the organizational assessment system. For example, questions may pertain to conformance to an ISO 9000 standard. Further, information received by assessment initiator system 210 may be suitably used to formulate the set of questions provided to the human assessors. For example, if the results of the assessment initiator system 210 indicate that the subject organization performs no manufacturing, questions stored in the memory 110 relating to manufacturing issues may be omitted. If the results of assessment initiator system 210 indicate that multiple standards are desired to be assessed, questions related to the multiple standards to be assessed may be selected. Additionally, questions which may be duplicated between two or more standards to be assessed may be omitted. For example, a question set directed to ISO 9000 and a question set directed to ISO 14000 may both contain questions regarding documentation of required training. In an embodiment, an assessor may only be asked one set questions pertaining to training documentation for evaluating both standards. The elimination of redundant questions may reduce the total amount of time required to complete the assessment. In an embodiment, one or more duplicate questions may be retained and addressed to one or more assessors. Retaining one or more duplicative questions may allow problem areas to be identified. For example, if a question regarding the effectiveness of a process is directed to two different assessors, and the two assessors provide significantly different answers, a problem area may be identified. A “problem area” may be an indication that an organizations process or system may not be in conformance to an aspect of a standard being used to evaluate the process or system.

Generally, information gathering system 212 may pose a series of questions, suitably in a conditional response format, to acquire information. The questions may be posed and the responses stored and analyzed, for example to establish the validity and substantiation of the responses. For example, a first input may be received from the input device of the computer system in response to a first question. The first input may be stored in the memory of the computer, and the first input may reflect the assessor's perception of the capability of the organizational process or system to address an issue.

Once the first input is received, it may be compared within a processing unit of computer 100 to a first value. If the first input has a first predetermined characteristic in relation to the first value then the method may involve prompting the assessor to identify evidence that supports the first input. A “predetermined characteristic” may be defined to mean, for example, that the input has a value at least as great, greater than, equal to or less than, or less than the first value. If the evidence identified by the assessor supports the first input, then the method may involve validating the first input for subsequent evaluation. If no evidence is provided or if the evidence identified does not support the first input, then the method may involve inhibiting validation of the first input until the evidence is identified or until the first input is changed to have a second predetermined characteristic in relationship to the first value.

The comparison and validation methods outlined above may have the effect of “filtering” data to remove unsupported, biased, erroneous, or exaggerated data. For instance, an assessor may be prevented from having a favorable rating validated for further evaluation if the assessor cannot identify evidence to support that favorable rating.

In an embodiment, the first input may be a numerical input selected from a scale, for example a 0-100% scale, a 1-3 scale, a 0-10 scale, or a 1-100 scale. This scale may be a sliding bar scale. For instance, the display device may display the following “issue” presented in the form of a statement:

Responsibilities and authorities for all personnel affecting quality are clearly defined and documented.

At this point, the assessor may be asked, “How well does your process (or system) address this issue?” The assessor may then input on a sliding scale of the computer (e.g., typically using arrow keys on a computer keyboard) his or her perception of how well the organization process (or system) addresses the above-referenced issue.

To illustrate, in one example the assessor might enter in a value of 65%, with 100% being, the best evaluation and 0% being the worst evaluation. In such an example, the first value may be, for example, 50%, and the first predetermined characteristic may be defined to mean that the first numerical input is greater than the first value. In this example, since the first numerical input (65%) is greater than the first value (50%), the first numerical input meets the first predetermined characteristic, and therefore the assessor may then be prompted to identify evidence that supports the first numerical input. Such “evidence” may be in various forms. For instance, it may be visible evidence that is simply affirmed by the assessor. In other embodiments the assessor may be requested identify evidence by name, document title, document creation date, review date, and/or other identifying properties.

In other embodiments, the first input may be a true/false or yes/no input, a numerical input, or a textual input. In addition, the first input may be a selection of only one item from a list of several choices. For example, with reference to the above illustration, an assessor may be asked to select one from the following list in response to a statement: very well, adequately, not well, not at all. Alternatively, the first input may be a selection of one or more applicable items from a list of several choices.

In one embodiment, the “evidence” may be affirmed by the assessor if the assessor indicates that the process or system is demonstrable (i.e., can be demonstrated). If the process or system is demonstrable, then the first numerical input may be validated for subsequent evaluation. If the system or process is not demonstrable, then validation of the first numerical input may be inhibited until the assessor indicates that the system or process is demonstrable or until the assessor changes the first numerical input to have a second predetermined characteristic in relationship to the first value. In this context, “validation” means that the numerical input is accepted by or into the computer for future evaluation.

In some embodiments, if evidence is not identified that supports the first input, then the display of subsequent questions may be inhibited until the evidence is identified or until the first input is changed to have the second predetermined characteristic in relation to the first value.

In an embodiment, the “second predetermined characteristic” may be defined to mean that the first input is less than the first value. In the example given above, if the first value is 50% and the assessor indicates that the first input is 65%, then the assessor may be asked to indicate that the process or system is demonstrable. If the assessor does so, then validation and/or display of subsequent questions proceeds. If the assessor does not, then validation may be inhibited, and/or the display of subsequent questions may be inhibited, until the assessor indicates that the process or system is demonstrable, or until the assessor changes the first input to be below 50% (e.g., 45%).

In an embodiment, further computer-driven questions may be displayed on the display device. These computer-driven questions may be adapted to prompt the assessor to input a second input on the input device of the computer. The second input may reflect the assessor's perception of how extensively the organizational process or system is deployed (i.e., how extensively the organizational process or system is actually used). For instance, after the first input is validated, the assessor may be asked to indicate how well the process being assessed is deployed. At this point the assessor may again answer a value (e.g., a percentage value on a 0-100 scale) that is indicative of how well the system or process is deployed. The term “how extensively the organizational process or system is deployed” refers to an assessment of how extensively processes or systems are actually deployed versus theoretically deployed.

The capability of an organizational process or system to address an issue refers to an assessment as to the ability of the theoretical organizational process or system to address an issue. In other words, the first input reflects an assessment as to whether the organizational process or system can address an issue. The second input then reflects how extensively the organizational process or system is actually deployed to address that issue. In other words, does the assessed process or system actually operate or does it sit on the shelf and/or only theoretically operate? For instance, a process or system may have a high (e.g., 90%) first input indicating that the process or system has a favorable ability to address the issue, but the second input may relatively low (e.g., 30%), indicating that process or system is not widely deployed.

Superior results have been achieved by prompting these questions together in conjunction with filtering techniques (examples of results achieved are shown in U.S. Pat. Nos. 5,737,494; 6,092,060; and 6,161,101 which are incorporated herein by reference). The results are achievable because an apparatus adapted to prompt these combinations of questions in conjunction with filtering techniques may address the following two phenomena frequently encountered when assessing a process or system: (1) a process or system is not supported by evidence but the users nevertheless use this process or system, or (2) the process or system is supported by evidence but it is not used. If either of these phenomena is present, then the first input relating to the assessed process or system may be dependent on knowledge embedded within workers. These workers, however, may quit, retire, be promoted, or otherwise cease performing, all without “passing on” the knowledge which enabled the assessed process or system to achieve the first input. Thus, the stability of the first input is questionable if either of these two phenomena is present.

The filtering techniques provide information concerning the first phenomenon. As described above, these filtering techniques also tend to inhibit favorable first inputs that are unsupported. Thus, these filtering techniques may increase the accuracy of the first input if the first phenomenon is present. The second input provides information concerning the second phenomenon. This information can be used with the first input in subsequent evaluations (e.g., by mathematical manipulation such as multiplying the first input by the second input to obtain a combined input value). Thus, an apparatus adapted to prompt the first and second numerical inputs, in combination with the filtering techniques, may have the effect of providing information about, and/or increasing the accuracy of, the first input. The above-described information that is provided “about the first input” can be reflective of the stability of the first input.

In the above-described manner, an assessor may be prompted to provide filtered numerical inputs that may together be used to evaluate the process or system. For instance, a first numerical input may be multiplied by a second numerical input (e.g., 90% times 30%=27%) to provide a multiplied evaluation factor that combines the characteristics of both inputs. Alternately, a plurality of first numerical inputs from various assessors may be used, and one or more standard deviations for the first and second numerical inputs may be calculated and compared or used in combination with each other for evaluation purposes. A wide variety of issues may be surveyed by a wide variety of assessors.

Many types of filtering techniques may be used in evaluating the inputs. For example, any sort of mathematical manipulations can be used, include multiplying, adding, subtracting, dividing, calculating standard deviations between, the first numerical input with the second numerical input, or vice versa.

The results of the filtering techniques may be evaluated to determine problem areas that might warrant on-site investigation. For instance, if 100 different issues were assessed by 10 different assessors, the average multiplied evaluation factor might be 55%, with only 8 issues being below 45%. On-site evaluation teams might then be directed to focus their efforts on investigating the 8 issues that were below 45% instead of all 100 issues, thereby saving manpower and expense. Alternately, the on-site teams could be directed to investigate issues that had standard deviations above a certain value (e.g., 8%). Again, the efforts of the on-site team would be focused and reduced, thereby saving manpower and expense.

Information or data collected may be sent via an intranet, extranet, the Internet, etc. Data collected may be sent to a computer in the form of a database, text files, graphics files, files viewable by a web browser, or other file formats. Additionally, data collected may be sent to a printer or data collection device such as memory 110 in computer 100. Further evaluation may be achieved by having one computer or control system automatically interact with another, wherein the second computer or control system is requested to gather or retrieve further data for validation or evaluation purposes. For instance, the second computer or control system may be adapted to provide information that verifies or confirms that numerical inputs are reasonably accurate.

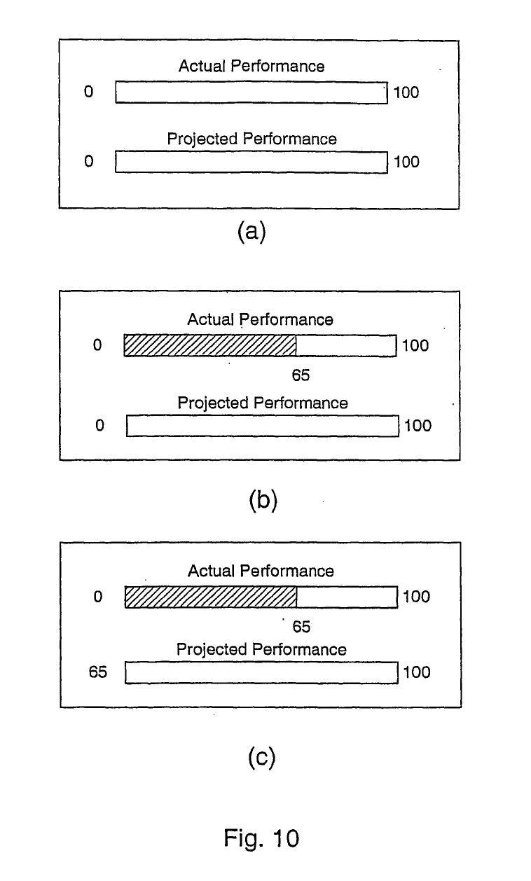

In addition to assessing an existing process or system, an organizational assessment system may be configured to prompt assessors to provide recommended changes or improvements to an existing process or system. In an embodiment, the recommendation may be accompanied by a measure of the expected benefit to accompany the recommendation. An assessor may provide numeric input via a user adjustable icon system. In an embodiment, a user adjustable icon system may comprise two user adjustable icons wherein the range of allowed input for a second user adjustable icon, is limited by input from a first user adjustable icon. In an embodiment, the user adjustable icons may be sliding bars, as depicted in FIGS. 10A-C. For example, the range of allowed second numerical input in a second selected scale may be limited by a first numerical input selection made on a first scale. In such an example, the first input may represent the assessor's perception of the effectiveness of an existing process or system, and the second numerical input may represent the assessor's perception of the expected effectiveness of the process or system after the recommended change is made. A user may be prompted to provide a first numeric input corresponding to the user's perception of the current performance of an organizational process or system (FIG. 10A). For example, a first input may be made by selecting 65 on a sliding bar having a range of 0-100 (FIG. 10B). The range of a second sliding bar for a second numerical input may then be limited by the computer to have a 65-100 scale (FIG. 10C).

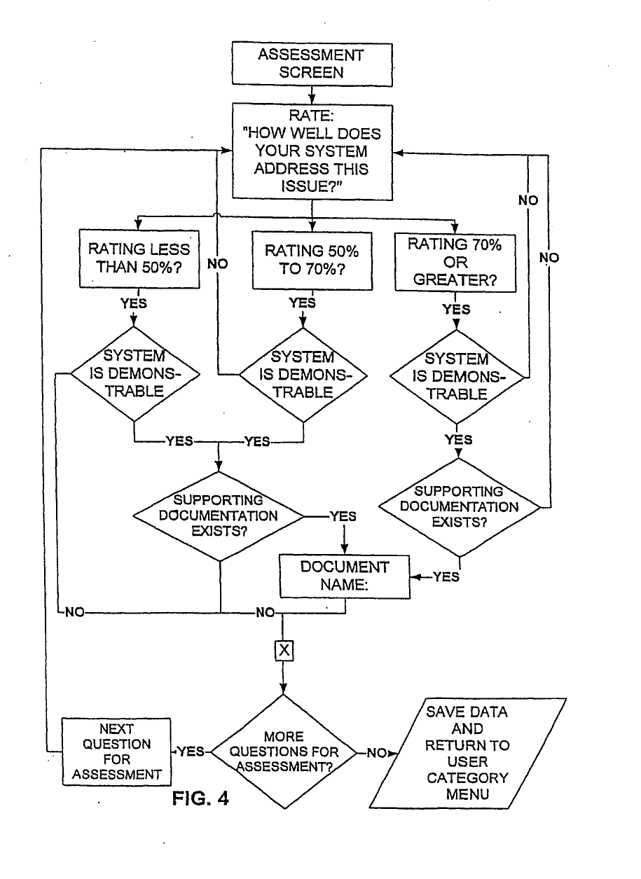

FIG. 4 demonstrates an embodiment which includes an assessment screen adapted to display a question in the form or a statement or issue. A “question” may be presented in multiple ways. For instance, a question may be a standard “yes/no” or “true/false” answer form (e.g., Does the ABC system maintain on-time performance records?). In addition, the question may be presented by making a statement, or stating an issue, and then asking the assessor to evaluate the statement or issue on a numerical scale. For instance, the assessor may be presented with the statement that “the ABC system maintains on-time performance records.” In response thereto, the assessor may enter a value on an analog scale reflecting the accuracy of the statement (e.g., 6 on a 1-10 scale, with 10 being the most favorable rating).

In FIG. 4, a series of statements or issues (such as those depicted in Table 1) may be shown on the assessment screen. The following question may then be displayed:

“How well does your system address this issue?”

At this point, the assessor may be prompted to input a numerical input, on an analog percentage scale, which reflects how well the assessed system addresses the issue. As shown by the arrows in FIG. 4, if the rating is less than 50%, then the assessor may be asked if the system is demonstrable. If the answer is “no,” then additional displays may be shown as represented by Box X in FIG. 4. If more questions are scheduled to be presented to the assessor, then the process or apparatus may proceed to the next question for assessment. If no more questions are scheduled, then the data may be saved and the assessor may be returned to a user category menu.

In FIG. 4, the first numerical input may be compared to other values besides the first value (the first value in this application acts as a trigger point, or set point). For instance, the first numerical input may be compared to determine if it is between 50-70%. If the first numerical input is between 50% and 70%, then the assessor may be asked to indicate whether the system is demonstrable; as shown in FIG. 4. If the system is not demonstrable, then the assessor may be asked to change the rating. In other words, the system shown in FIG. 4 may inhibit display of subsequent questions if evidence (e.g., system demonstrability) is not presented that will support ratings in the range of 50-70%. In FIG. 4, if the first numerical input is between 50-70% and the system is demonstrable, then the assessor is asked further questions as outlined above for FIG. 4 (e.g., if supporting documentation exists, etc.).

The system in FIG. 4 also has the capability of comparing the first numerical input to a third value. If the first numerical input is 70% or greater, then the assessor is asked to determine if the system is demonstrable. If the system is not demonstrable, then the apparatus inhibits display of subsequent questions until the assessor changes the rating (i.e., lowers the first numerical input below 70%). If the system is demonstrable, the assessor is subsequently asked if supporting documentation exists. If the assessor indicates that no supporting documentation exists, then again the display or subsequent questions is inhibited until the assessor indicates that supporting documentation exists or changes the first numerical input to a lesser value.

In FIG. 4, Box X may indicate that the first numerical input is validated. In this context “validation” may simply mean that the first numerical input is stored, that the assessor is not inhibited from proceeding to subsequent questions, and/or that the display of subsequent questions is not inhibited.

The process shown in FIG. 4 may have the effect of “filtering” assessment indicia. As shown in FIG. 4, as the rating (i.e., numerical input) becomes more favorable (i.e., higher), then greater levels of evidentiary support may be required. If the rating is less than 50%, then the assessor may still proceed to Box X even if the assessed system is not demonstrable. Of course, if the assessed system is demonstrable, then information is received by the apparatus, and if the supporting documentation exists, that information is also received by the apparatus. If the first numerical input is between 50-70%, then a greater level of evidence may be required before the assessor may proceed to Box X. Specifically, at least system demonstrability must be indicated. Otherwise, the assessor must change (e.g., lower) the first numerical input. Again, if supporting documentation exists, the information is received by the apparatus. Finally, if the numerical input is 70% or greater, then system demonstrability and supporting documentation must exist. Otherwise, the assessor must change the first numerical input to a lesser value.

In effect, the apparatus shown in FIG. 4 filters the data collected by inhibiting validation/collection of exaggerated, untrue, and/or unsupported numerical inputs. Furthermore, as a numerical input becomes more favorable, then the level of support required for that rating also increases.

The numerical input shown in FIG. 4 may be modified based on a wide variety of factors preferred by the apparatus designers. For instance, in some processes alternate rating systems may be preferred (e.g., a rating system of 1-10, where 1 is the most favorable rating). In such a case, appropriate revision of the levels of evidence as correlated to numerical inputs would be required. In some instances, numerical inputs may be utilized to indicate specific events or circumstances (e.g., 1=daily, 2=weekly, 3=monthly, 4=yearly, or 1=always, 2=sometimes, 3=never, etc.)

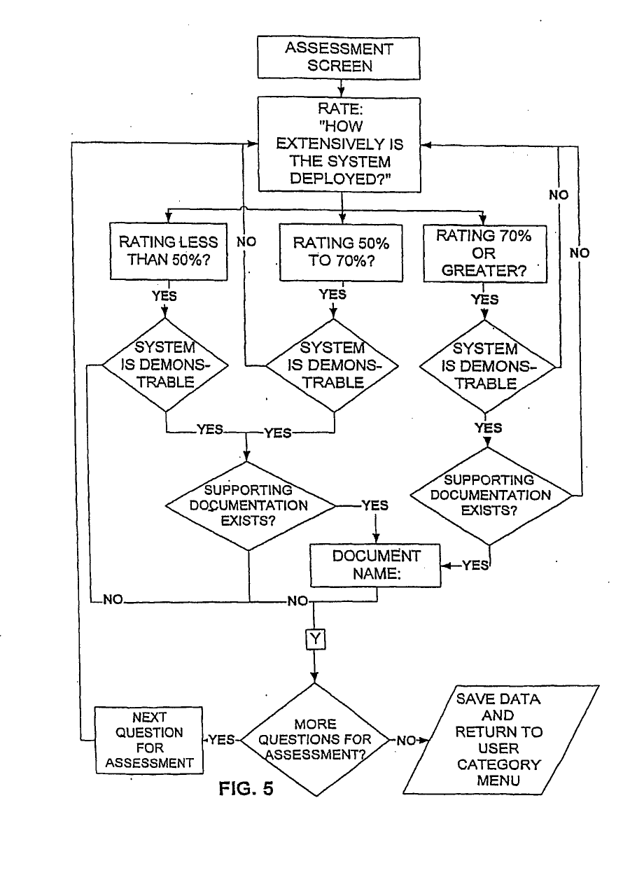

In FIG. 4, Box X may represent a series of subsequent questions presented to the assessor. For instance, Box X may be represented by the process shown in FIG. 5. In FIG. 5 a question may be displayed on a display device which would ask for a second numerical input reflecting the assessor's perception of how extensively the organizational process or system is deployed. Again, a filtering apparatus may be employed in conjunction with the second numerical input to correlate more favorable ratings with varying levels of evidence. This filtering apparatus may be similar to the FIG. 4 filtering apparatus. Depending on the level of the second numerical input, then varying levels of evidence may be required to arrive at Box Y. Box Y may serve similar purposes as Box X. That is, it may serve to validate the second numerical input, or represent subsequent questions to be displayed to the assessor.

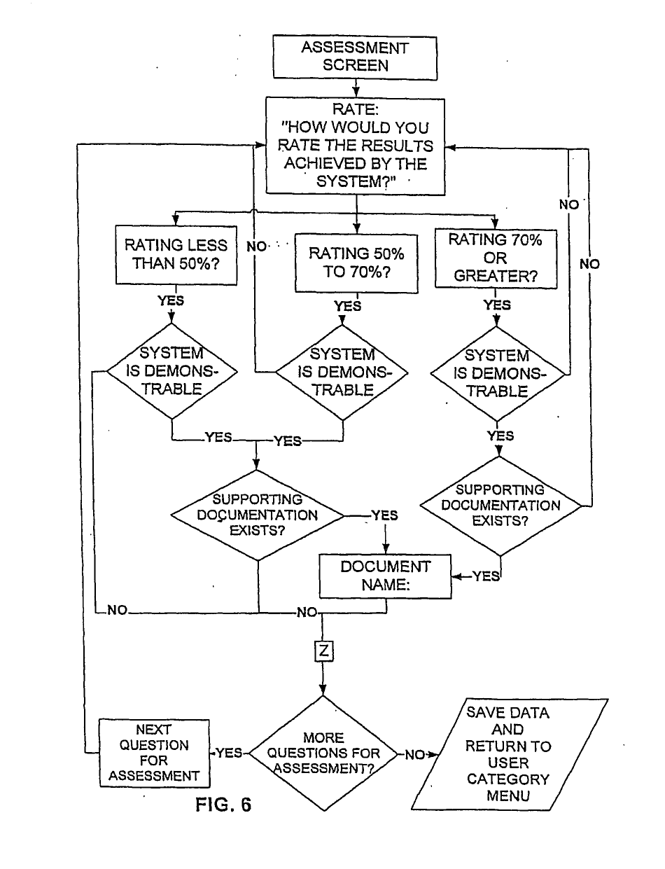

FIG. 6 depicts a process analogous to that of FIG. 4, except the initial questions is:

“How would you rate the results achieved by the system?”

In FIG. 6, a third numerical input is input into the system, the third numerical input reflecting the assessor's perception of the results achieved by the organizational process or system. A filtering apparatus similar to the filtering system shown in FIG. 4 may also be employed. Box Z in FIG. 6 may represent subsequent questions to be asked.

Some embodiments may employ the process of FIG. 4 with the process of FIG. 5, the process of FIG. 4 with the process of FIG. 6, the process of FIG. 4 with the systems of FIGS. 2 and 3, and the process of FIG. 5 with the process of FIG. 6. Furthermore, the order of the processes may be reversed or mixed. For example, questions presented in the process of FIG. 5 may be asked first followed by questions in the process of FIG. 4.

A process combining FIG. 4 with FIG. 5 may provide superior evaluation results. It is believed that the superior results may be achieved because the process of FIG. 4 provides an assessment as to how well a system may address an issue, however it does not provide an assessment on how extensively the system is deployed. Thus, a system may work (i.e., address an issue) particularly well (i.e., greater than 90%); however, it may only be minimally deployed. By using the processes of FIG. 4 and FIG. 5, an assessment as to the capability of the system combined with an assessment as to system deployment may be achieved. For instance, if the system addresses the issue particularly well (i.e., at 90%) but is only 60% deployed, then in one embodiment a combined assessment of 90% times 60%=54% may be calculated. Such combined assessments may be particularly helpful to focus on-site assessment team efforts.

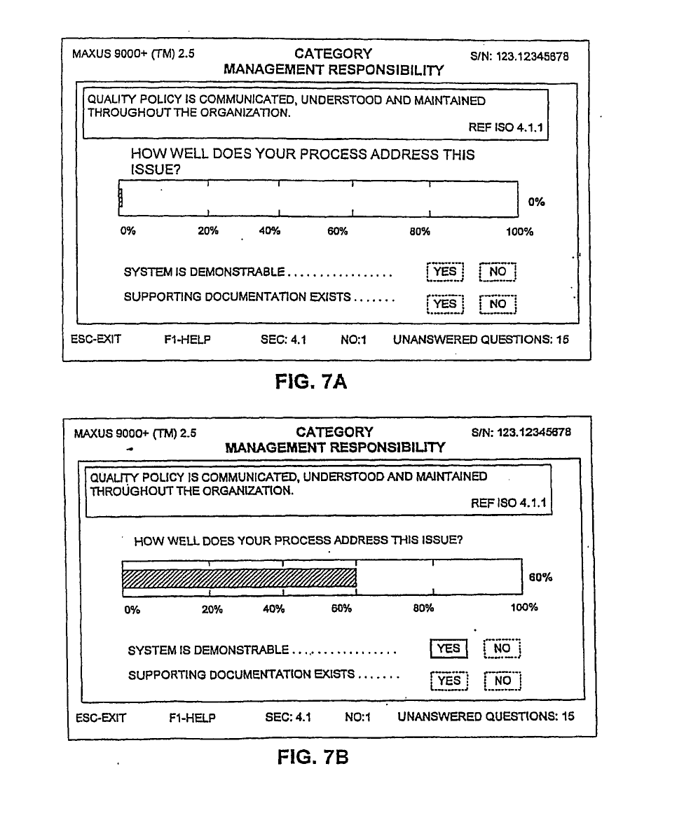

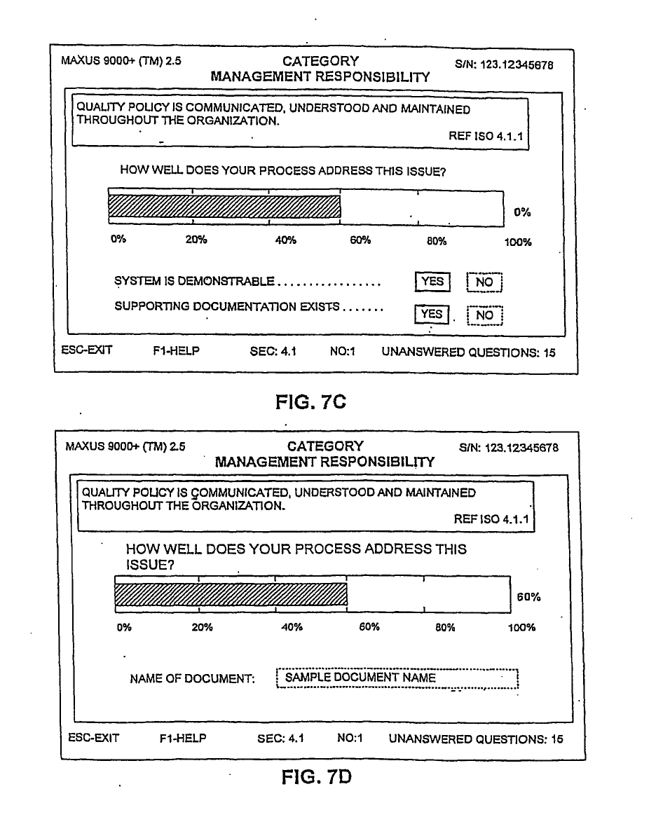

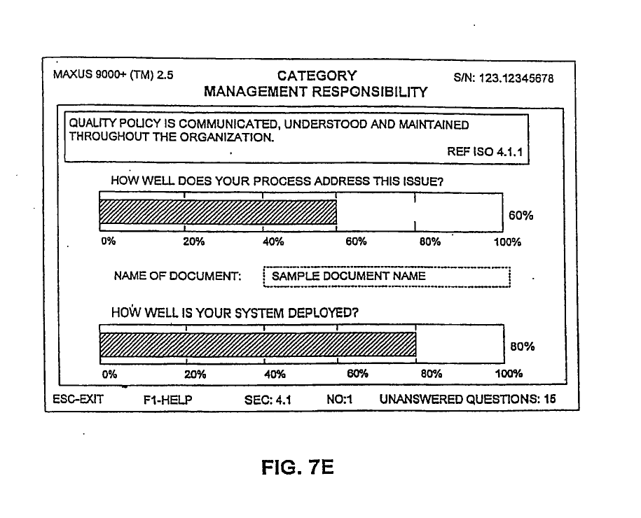

FIGS. 7A-7E depict a series of screen displays for the VIRTUAL ASSESSOR (formerly MAXUS and MAXSYS) process/apparatus provided by Intellimet, Inc (Scottsdale, Ariz.). As shown in FIG. 7A, the following initial “issue” or statement within the category “management responsibility” is displayed: “Quality policy is communicated, understood and maintained throughout the organization.” The assessor is then prompted to input, on a sliding bar 0-100% scale, a first numerical input that reflects his or her perception as to how well the assessed process (or system) addresses this issue. As shown in FIG. 7B, the assessor in this example input a first numerical input of 58%.

At this point the assessor may be prompted (e.g., the word “yes” is highlighted) to indicate whether the system is demonstrable or not. Such indication may be made by the assessor pressing the “enter” key when “yes” is highlighted. To indicate “no” the assessor may use an input device to move the highlight so that “no” is highlighted instead of “yes” and then pressing the “enter” key. If the first numerical input of 58% is higher than a first value (e.g., higher than 50%), then the assessor may be required to indicate that the assessed system is demonstrable. Otherwise, the apparatus may inhibit display of subsequent questions and/or prompt the assessor to provide a new (and in this case a lower and less favorable) first numerical input. In this example, the assessor indicated “yes” so subsequent questions were not inhibited and the assessor was not asked to input a new numerical input.

As shown in FIG. 7C, the process may then prompt the assessor to indicate whether supporting documentation existed. If the first numerical input (here, 58%) is higher than a second value (e.g., higher than 60%), then the assessor may be required to indicate that supporting documentation exists. Otherwise, the apparatus may inhibit display of subsequent questions and/or prompt the assessor to provide a new (and in this case a lower and less favorable) first numerical input. In this example, the assessor indicated “yes” so, as shown in FIG. 7D, the apparatus prompted the assessor to identify documents by providing document names.

The “system is demonstrable” and “supporting documentation exists” statements, and their associated “yes or no” questions are filtering mechanisms to help inhibit/prevent collection of exaggerated or untrue data. Using known empirically gathered information, the apparatus may be adapted to have first, second, or subsequent values that serve as “trigger” or “set” points to require higher levels of evidentiary support. The theoretical basis for this apparatus is that, on average, filtered perceptions of quality, as indicated by relatively high first numerical inputs, reflect actual conditions. For instance, in the example shown above, a system must be demonstrable to support a first numerical input rating greater than the first value (here, greater than 50%), and then the system must have supporting documentation to support a first numerical input rating higher than a second value (e.g., higher than 60%).

After entering at least one document name, document date, etc. in FIG. 7D, the display screen shown in FIG. 7E may be displayed. FIG. 7E prompts the assessor to input a second numerical input which reflects the assessor's perception of how well the process is deployed. In other words, the assessor inputs a numerical evaluation of how extensively the assessed process (or system) is actually used or deployed.

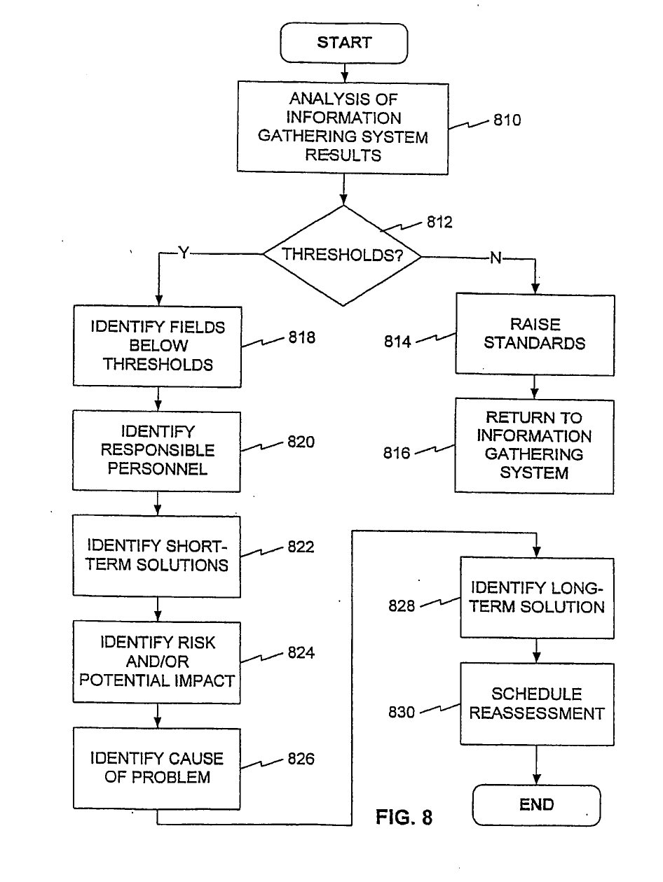

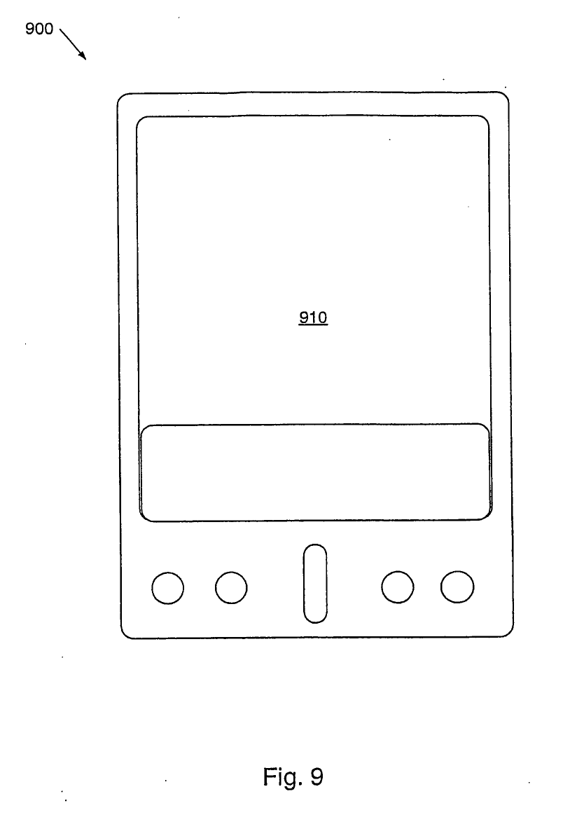

Upon completion of information gathering system 212, corrective action system 214 may be initiated. Corrective action system 214 may analyze the data accumulated by information gathering system 212 to identify problem areas and explore resolution of the problems. Referring now to FIG. 8, the corrective action system may analyze the data gathered by information gathering system 212 to detect problem areas (step 810). For example, the data for each of the fields, i.e., the topics addressed by the information gathering system, may be summarized into a single value for the field. The summary may be generated in any manner, such as statistical methods like finding the mean, median, or mode of numerical responses. To identify specific problem fields, the summarized results may be compared to selected thresholds (step 812). The thresholds may be selected in any suitable manner, for example approximating industry average values for such fields or minimum values required to satisfy particular evaluation criteria. Results may also be compared across assessors or standards assessed. For example, in the information gathering system, two or more assessors may be asked similar or related questions. The results of the answers provided may be compared to determine if inconsistent answers were provided. Likewise, one or more similar or related questions may be presented with regard to different standards being assessed, and answers may be compared to determine if inconsistent answers were provided.

If all of the summary values for the fields exceed the selected thresholds, and no inconsistent answers are identified the corrective action system may terminate. Alternatively, the thresholds may be raised to a level corresponding to an improved state of operation (step 814) and the results analyzed again in view of the new set of thresholds (step 816). In any event, if any of the summarized values fail to exceed the selected thresholds, or inconsistent answers are identified, the particular fields are identified for further analysis (step 818).

Following identification of the relevant fields, the corrective action system may generate a set of questions for each of the relevant fields and pose them to the appropriate personnel. The appropriate personnel are likely to be the personnel identified in conjunction with the application initiator system as being in charge of the departments associated with the relevant fields. The questions may be designed to assess the magnitude of the problem, the cause of the problem, and/or solutions to the problem. For example, a first set of questions may require designation of a responsible person or persons for addressing the problem (step 820). A next set of questions may be designed to determine optimal short-term solutions to the problem to be implemented by the designated responsible person (step 822).

After identifying short-term solutions, the corrective action system may provide questions relating to a more complete solution of the problem. For example, a set of further questions may be presented to determine the magnitude of the risk and/or potential impact associated with the problems in the field (step 824). Additional questions are suitably presented to identify the fundamental causes of the problem (step 826) and potential solutions for neutralizing those causes and remedying the problem (step 828). Finally, the corrective action system may implement a calendaring set of questions configured to interactively generate a timetable for resolution of the problem and performance of a supplementary organizational assessment within the problem fields (step 830). Notification system 216 may generate a timeline for completion of corrective actions or for a supplementary organizational assessment based on the calendaring questions. Notification system 216 may provide notification to identified individuals of timelines and/or due dates for corrective actions or supplementary organizational assessments. Notification system 216 may also provide notification of deadlines which may be exceeded.

Once the assessment information is collected and evaluated, reports may be created summarizing the information, suitably by computer 100. For example, these reports might identify an organization's strengths and weaknesses. The report might also suggest guidelines for the organization to improve the weaknesses, for example in accordance with the information accumulated by corrective action module 214. In an embodiment, the report generating process may include information relating to the correlation of the respondents' responses with one another, a summary of the respondents' views relating to various issues, additional sources of data identified by the respondents, or any other information which may be drawn from or generated in conjunction with the information obtained by the organizational assessment system.

Information gathered in the assessment may be stored in a database in the memory 110 of computer 100. The database may be configured to allow an authorized user to search for information related to an organization or assessment. For example, a search may be conducted to identify a company which manufactures a particular item and has various characteristics which may be determined by the organizational assessment system.

Although the present invention is directed towards computer-driven assessments, computers may not be available to the assessors who need to answer questions. Therefore, an organizational assessment system according to various aspects of the present invention may be configured to generate a set of questions suitable for printing to hard copy for use. Preferably, the particular selection of questions is generated following a computer-driven implementation of assessment initiator system 210. Based on the responses provided by the human assessor to assessment initiator system 210, a selection of questions may be derived from a collection of questions stored in memory 110 of computer 100. Further human assessors are given hard copies of the questions and answer sheets. The answer sheets typically contain numbers which correspond to the question numbers. Next to the answer sheet numbers are a plurality of circles or other indicia which correspond to the answer choices presented with each question. To answer a question, the assessor may darken the circle or otherwise marks or designates the area which corresponds to the appropriate answer. The answer sheets may be entered into a computer system. In an embodiment, the answers sheet may be scanned into computer 100 and the assessment, including information gathering system 212 and corrective action system 214, can be continued on the computer.

In an embodiment of the invention, the apparatus and process of the invention may be adapted to compare numerical inputs (relating to a plurality of issues, or categories of issues) for a plurality of suppliers. In this manner an objective, relatively quick and inexpensive assessment of the suppliers may be completed. Additionally, industry standards may be established, and on-site evaluations may be directed to focus their inspection efforts in areas that are below, or not within, industry norms.

Methods and apparatus of an organizational assessment system as described herein may be useful to reduce the scope of onsite assessments performed by an organization. For example, a first company desiring to assess a second company may traditionally employ assessors to go onsite at the second company to gather information related to the standards to be assessed. Typically, the second company may be a supplier of materials or services to the first company. Embodiments described herein may be used by the first and second companies to reduce the amount of specific information to be gather by onsite assessors by identifying areas which may be of concern, and areas which may not be of concern. Additionally, a first company may employ embodiments described herein to determine which organization or organizations from a group of organizations to perform onsite assessment of. For example, a first company may have 100 suppliers. Data gathered by embodiments described herein may be used to identify suppliers which pose the greatest risk to the first company (that is suppliers with processes or systems which do not conform to the assessed standard, or suppliers which supply products or services deemed critical to the first companies business.)

In an embodiment where onsite assessment is in conjunction with the method and apparatus described herein, onsite assessors may be provided data gathered by the assessment initiator system, information gathering system 212, and/or corrective action system 214. Data provided to onsite assessors may include for example, areas for which corrective actions were required, corrective action plans, and corrective action timelines. Data provided to onsite assessors may be in an electronic format, for example, assessors may be provided with a PDA 900, such as Palm Pilot, available from Palm, Inc. Assessment data may be loaded into memory 910 of the PDA 900 A software application in the memory 910 of the PDA 900 may allow the onsite assessor to view assessment data, and edit or add some data. Onsite assessors may verify information provided by assessors, status of corrective actions, etc. Information gathered by onsite assessors may be placed into a database in the memory 110 of computer 100. Information provided by onsite assessors may be in the form of numerical answers to questions posed.

The organizational assessment system may be configured to adjust individual onsite assessor's answers. An estimate of an onsite assessor biases may be the basis for adjusting the individual assessor's answers. An assessor may be asked a series of questions to gauge the individual's biases statistically, as compared to other onsite assessors previously asked the same question. For example, an auditor may be asked to rate the percent complete of a given corrective action plan based on given information. The assessor's numeric answer may then be compared to the answers of other assessors previously asked the same question. An overall average answer may be established as a reference point, the individual assessor may then be assigned a bias score as related to the average. Each assessor's onsite assessment answers may be adjusted by a bias score thus established.

TABLE 1
4.1 MANAGEMENT RESPONSIBILITY

| | |
|---|---|
| 1. | Quality policy is communicated, understood and maintained throughout the organization. |
| | (I.4.1.1) |
| 2. | Responsibilities and authorities for all personnel affecting quality are clearly defined and |
| | documented. (I.4.1.2) |
| 3.1 | Authority delegated to personnel to prevent nonconformity reoccurrence. (I.4.1.2) |
| 3.2 | Authority delegated to personnel to Identify & record quality problems. (I.4.1.2) |
| 3.3 | Authority delegated to personnel to initiate & verify corrective action. (I.4.1.2) |
| 3.4 | Authority delegated to personnel to control further processing. (I.4.1.2) |
| 4. | A multi-disciplinary approach is used in the design process with direct input in decision |
| | making. (I.4.1.2) |
| 5. | Periodic top management review of quality system effectiveness is supported by appropriate |
| | records. (I.4.1.3) |
| 6. | Qualified technical personnel are available for design, process, product and service support. |
| | (I.4.1.2.2) |
| 7. | Management representative with authority & responsibility to ensure standards compliance |
| | (i.e. ISO-9000, QS-9000, NQA, etc.) is clearly defined. (I.4.1.2.3) |
| 8.1 | Documented business plan(s) consider standard's requirements (i.e. ISO-9000, QS-9000, |
| | NQA, etc.) including competitive product analysis. (as applicable) (I.4.1.4) |
| 8.2 | Documented business plan(s) considers the standard's requirements (i.e. ISO-9000, QS- |
| | 9000, NQA, etc.) and benchmarking. (as applicable) (I.4.1.4) |
| 8.3 | Documented business plan(s) considers standard's requirements (i.e. ISO-9000, QS-9000, |
| | NQA, etc.) and R&D plans. (as applicable) (I.4.1.4) |
| 8.4 | Documented business plan(s) considers standard's requirements (i.e. ISO-9000, QS-9000, |
| | NQA, etc.) of internal quality and operational performance measures (as applicable) (I.4.1.4) |
| 9. | Data is used to focus on competitors and/or appropriate benchmarks for improving quality, |
| | productivity, and operation efficiency. (I.4.1.5) |
| 10. | Documented and objective processes are used to measure customer satisfaction. (e.g.: a |
| | plan with short and long term actions addressing customer dissatisfaction factors.) (I.4.1.6) |
| 11. | Cross-functional teams are used for the quality planning process. (I.4.2.1) |

4.2 QUALITY SYSTEM

| | |
|---|---|
| 1. | Quality Manual adequately meets QS-9000 requirements for documentation of a |
| | comprehensive quality system. |
| 2.1 | Quality planning process is consistent with the elements of the quality system that addresses |
| | Product Program plan preparation. (I.4.2.3) |
| 2.2 | Quality planning process is consistent with the elements of the quality system that addresses |
| | identification and acquisition of the appropriate resources. (I.4.2.3) |
| 2.3 | Quality planning process is consistent with the elements of the quality system and addresses |
| | conducting design and process compatibility studies. (I.4.2.3) |
| 2.4 | Quality planning process is consistent with the elements of the quality system and addresses |
| | updating and maintenance of all quality control and inspection methodology. (I.4.2.3) |
| 2.5 | Quality planning process is consistent with the elements of the quality system and addresses |
| | identification of suitable verification at appropriate stages. (I.4.2.3) |
| 2.6 | Quality planning process is consistent with the elements of the quality system and addresses |
| | preparation of control plans and FMEAs. (I.4.2.3) |
| 2.7 | Quality planning process is consistent with the elements of the quality system and addresses |
| | review of standards and specifications. (I.4.2.3) |
| 3. | Feasibility reviews are conducted to confirm the compatibility of design with the manufacturing |
| | process, including capacity planning and utilization. (I.4.2.3) |
| 4. | Engineering requirements are met at the required statistical process capability. (I.4.2.3) |
| 5. | Control plans are developed to the subsystem, component, and/or material level. (I.4.2.3) |
| 6. | Control plans include all special characteristics, related process and parameters - and are |
| | identified as such. (I.4.2.3) |
| 7. | Control plans are revised when appropriate for product and process changes or when |
| | processes are found to be unstable or non-capable. (I.4.2.3) |
| 8. | Control plans cover three phases: prototype, pre-launch, production (unless exempted by the |
| | customer). (I.4.2.3) |
| 9. | Process FMEAs consider all special characteristics. (I.4.2.3) |
| 10. | Adequate supporting procedures exist for each element of the quality manual. (4.2.2) |
| 11. | Special characteristics have been identified and included in the Control Plan(s). (I.4.2.3.a) |
| 12. | A comprehensive quality system (appropriate to the product or service produced) is |
| | established and implemented. (4.2.1) |

4.3 CONTRACT REVIEW

| | |
|---|---|
| 1. | Contract review activities are adequately documented and maintained to ensure that order |
| | requirements are understood and are within the supplier's capability prior to order acceptance. |
| | (I.4.3.2) |
| 2. | Standard's requirements (i.e. ISO-9000, QS-9000, NQA, etc.) and customer contract |
| | requirements are deployed into the quality system. (I.4.3.2) |
| 3. | Provisions to document and deploy contract changes throughout the organization exist. |
| | (I.4.3.3) |
| 4. | Contract review records are maintained. (I.4.3.4) |

4.4 DESIGN CONTROL

| | |
|---|---|
| 1. | Design plans for each project have been established and responsibility assigned. (I.4.4.2) |
| 2. | Responsible personnel are experienced in the “required skills” or appropriate equivalents. |
| | (I.4.4.2) |
| 3. | Applicable statutory and regulatory requirements are identified. (I.4.4.4) |
| 4.1 | Appropriate resources and facilities are available to use computer aided design, engineering |
| | and analysis. (I.4.4.4) |
| 4.2 | Technical leadership is provided when CAD/CAE is sub-contracted. (I.4.4.4) |
| 5. | Formal documented design reviews are conducted per the design plan. (I.4.4.5) |
| 6. | Design output is documented and expressed as requirements that can be verified. (I.4.4.6) |
| 7.1 | Design output meets design input requirements. (I.4.4.6) |
| 7.2 | Design output contains or references acceptance criteria. (I.4.4.6) |
| 7.3 | Design output includes a review of design output documents before release. (I.4.4.6) |
| 8.1 | Design outputs are the result of a process that used the “Design Techniques” or alternatives? |
| | (I.4.4.2) & (I.4.4.6) |
| 8.2 | Design outputs are the result of a process that used Geometric Dimensioning and Tolerancing |
| | (GDT). (I.4.4.6) |
| 8.3 | Design outputs are the result of a process that used analysis of cost/performance/risk |
| | trade-offs. (I.4.4.6) |
| 8.4 | Design outputs are the result of a process that used feedback from testing, production and |
| | the field. (I.4.4.6) |
| 8.5 | Design outputs are the result of a process that used analysis of design failure mode and |
| | effects (DFMEA). (I.4.4.6) |
| 9. | Performance testing (life, durability, reliability) is tracked for timely completion and |
| | conformance. (I.4.4.7) |
| 10. | A comprehensive prototype program exists (unless waived by the customer or made |
| | unnecessary by the generic nature of the product supplied). (I.4.4.7) |
| 11. | Design validation has been performed at the specified frequencies, results recorded, and |
| | failures addressed. (I.4.4.8) |
| 12. | Design changes are documented and approved by authorized personnel before |
| | implementation. (I.4.4.9) |
| 13. | Written customer approval or waiver has been obtained prior to a design change being |
| | implemented into production. (I.4.4.9) |

4.5 DOCUMENT AND DATA CONTROL

| | |
|---|---|
| 1. | New and revised documents are reviewed and approved by authorized personnel prior to |
| | issue. (I.4.5.2) |
| 2. | A master list (or equivalent) identifies document revision status. (I.4.5.2) |
| 3. | Timely review, distribution and implementation of customer engineering standards, |
| | specifications and changes. (I.4.5.2) |
| 4. | All referenced documents are available on-site. (I.4.5.1) |
| 5. | Special characteristic symbols or notations are shown on process control plans and similar |
| | documents. (I.4.5.1) |
| 6. | Where documents or data is retained on software, appropriate controls are maintained for |
| | changes. (I.4.5.1 & 3) |

4.6 PURCHASING

| | |
|---|---|
| 1. | Subcontractors are evaluated and selected based on their ability to meet quality system and |
| | quality assurance requirements. (I.4.6.2.a) |
| 2. | Appropriate level of control over subcontractors is maintained. (I,4.6.2.b) |
| 3. | Quality records of subcontractors are kept up to date and used to evaluate performance. |
| | (I.4.6.2.c) |
| 4. | Subcontractor development is conducted using the standard's requirements (i.e. ISO-9000, |
| | QSR (Sections I & II), NQA, etc.) as the fundamental quality system requirement. (I.4.6.2) |
| 5. | Purchasing documents contain data that clearly describe the product or service being |
| | ordered. (I.4.6.3) |
| 6. | Where applicable, there is provision for the customer (or representative) to verify |
| | subcontractor quality on the subcontractor's premises. (I.4.6.4.2) |

4.7 CONTROL OF CUSTOMER SUPPLIED PRODUCT

| | |
|---|---|
| 1. | Material is examined upon receipt to check quantity, identity, and transit damage. (I.4.7) |
| 2. | Material is periodically inspected to detect signs of deterioration, proper conditions & storage |
| | time limitations. (I.4.7) |
| 3. | For product that is lost, damaged or otherwise unsuitable for use, records are maintained and |
| | reports provided to the customer. (I.4.7) |

4.8 PRODUCT IDENTIFICATION AND TRACEABILITY

| | |
|---|---|
| 1. | Product is identified, where appropriate, at all production stages? (I.4.8) |
| 2. | Traceability is maintained and recorded when required by the customer? (I.4.8) |

4.9 PROCESS CONTROL

| | |
|---|---|
| 1.1 | Documented job instructions have been developed and are accessible at each work station. |
| | (I.4.9) |
| 1.2 | Documented job instructions communicate requirements to all employees involved. (I.4.9) |
| 1.3 | Documented job instructions provide for verification of job set-ups and tool change intervals. |
| | (I.4.9) |
| 1.4 | Documented job instructions specify monitoring of special characteristics. (I.4.9) |
| 1.5 | Documented job instructions list requirements for inspection, testing, gaging and recording |
| | results. (I.4.9) |
| 1.6 | Documented job instructions provide sample size and frequency. (I.4.9) |
| 1.7 | Documented job instructions establish approval and rejection criteria. (I.4.9) |
| 1.8 | Documented job instructions list required tools and gages (with mastering at required |
| | frequency). (I.4.9) |
| 1.9 | Documented job instructions describe the identification and handling of non-conforming |
| | material. (I.4.9) |
| 1.10 | Documented job instructions specify appropriate notifications and corrective actions (including |
| | plans for unstable/non-capable processes). (I.4.9) |
| 1.11 | Documented job instructions specify application of statistical methods required by control |
| | plans. (I.4.9) |
| 1.12 | Documented job instructions identify relevant engineering and manufacturing standards and |
| | the latest engineering change affecting the instruction. (I.4.9) |
| 1.13 | Documented job instructions display appropriate approvals and dates. (I.4.9) |
| 1.14 | Documented job instructions display operation name and number. (I.4.9) |
| 1.15 | Documented job instructions are keyed to process flow charts. (I.4.9) |
| 1.16 | Documented job instructions show part name and number. (I.4.9) |
| 1.17 | Documented job instructions show revision date for instructions. (I.4.9) |
| 1.18 | Documented job instructions define visual controls. (I.4.9) |
| 2. | Employees perform operations/inspections according to documented instructions. |
| 3.1 | Process control requirements are met. |
| 3.2 | The customer's preliminary process capability requirements are met. (I.4.9.2) |
| 3.3 | The customer's ongoing process performance requirements are met. (I.4.9.3) |
| 3.4 | Special causes of variation are investigated and appropriate actions taken. (I.4.9.3) |
| 3.5 | Control charts are annotated with significant process events. (I.4.9.3) |
| 3.6 | Control charts are maintained and reviewed with highest priority given to special |
| | characteristics. (I.4.9.3) |
| 4.1 | Planned preventive maintenance system includes a maintenance schedule established with |
| | specific responsibilities assigned. (I.4.9.g) |
| 4.2 | Planned preventive maintenance system is evaluated for process capability improvement. |
| | (I.4.9.g) |
| 4.3 | Planned preventive maintenance system is evaluated for reduction of machine/process |
| | downtime. (I.4.9.g) |
| 4.4 | Maintenance is conducted at the prescribed frequencies for all equipment. (I.4.9.g) |
| 4.5 | Planned preventive maintenance system tracks availability of replacement parts for key |
| | manufacturing equipment. (I.4.9.g) |
| 4.6 | Planned preventive maintenance system uses predictive maintenance methods. (I.4.9.g) |
| 5. | A process exists to identify all applicable government safety and environmental regulations, |
| | including those concerning handling, recycling, eliminating, or disposing of hazardous |
| | materials. (I.4.9.b) |
| 6. | Possession of appropriate governmental certificates indicating compliance to the identified |
| | applicable regulations. (I.4.9.b) |
| 7. | Work environment is clean and well-organized. (I.4.9.b) |
| 8.1 | Evaluation areas for “appearance items” have appropriate lighting. |
| 8.2 | Appropriate masters of “appearance items” are available. |
| 8.3 | “Appearance Item” masters and evaluation equipment are adequately maintained. |
| 8.4 | Verification exists that personnel making appearance evaluation are qualified to do so. |

4.10 INSPECTION AND TESTING

| | |
|---|---|
| 1.1 | Purchased material is controlled and verified per the selected system prior to release to |
| | production. (I.4.10.2) |
| 1.2 | Positive identification is provided for material used in production but not verified. (I.4.10.2) |
| 1.3 | Where specified as the control method, suppliers submit statistical data. (I.4.10.2) |
| 2.1 | Product is inspected and tested as required by the documented procedures. (I.4.10.3) |
| 2.2 | Product is held until the required inspections and tests have been completed. (I.4.10.3) |
| 2.3 | Defect prevention methods, such as statistical process control, error proofing, visual controls, |
| | is used rather than defect detection. (I.4.10.3) |
| 3.1 | Final inspection and testing is conducted in accordance with documented procedures. |
| | (I.4.10.4) |
| 3.2 | Final inspection and testing ensures no product is shipped until all activities specified in the |
| | documented procedures have been satisfactorily completed. (I.4.10.4) |
| 4. | Accredited laboratory facilities are used when required by the customer. (I.4.10.1, II.1) |
| 5.1 | Layout inspection is conducted per the Control Plan. (I.4.10.4) |
| 5.2 | Functional testing is conducted per Control Plan. (I.4.10.4) |
| 6. | Appropriate records are maintained for all inspections and tests. (I.4.10.5) |

4.11 INSPECTION, MEASURING, AND TEST EQUIPMENT

| | |
|---|---|
| 1. | Inspection, measuring, and test equipment (including software when appropriate) has been |
| | provided that is capable of the required accuracy and precision. (I.4.11.2.a) |
| 2. | Required accuracy/precision of inspection, measuring, and test equipment is determined. |
| | (I.4.11.2.a) |
| 3. | Measurement system analysis is conducted (Gage R & R) for all gages, measuring, and test |
| | equipment, noted on the control plan. (I.4.11.4) |
| 4. | Appropriate criteria (per the Measurement Systems Analysis Manual) is used for acceptance |
| | of measuring equipment. (I.4.11.4) |
| 5. | Where test software, hardware, or comparative references are used, capability and stability |
| | are verified prior to use (linearity and accuracy as appropriate). (I.4.11.2) |
| 6. | Each item of inspection, measurement, and test equipment is identified with a unique |
| | designation (including employee-owned equipment)? (I.4.11.3) |
| 7. | Each piece of inspection, measurement, and test equipment is calibrated at prescribed |
| | intervals and in the correct environment (including employee-owned equipment). (I.4.11.2.b) |
| 8. | Gage condition and actual readings are recorded prior to recalibration. (I.4.11.2.e) |
| 9. | Appropriate actions, including customer notification, are taken on product and process when |
| | inspection, measurement, or test equipment is found to be out of calibration. (I.4.11.2.f) |
| 10. | Inspection, measurement, and test equipment are properly handled, preserved, and stored to |
| | maintain calibration and fitness for use. (I.4.11.2.h) |
| 11. | Inspection, measurement, and test facilities (including software when applicable) are |
| | safeguarded to insure that calibration is not disturbed. (I.4.11.2.i) |
| 12. | Records exist for recalibration of part-specific gages, etc. following engineering changes. |
| | (I.4.11.2) |

4.12 INSPECTION AND TEST STATUS

| | |
|---|---|
| 1. | Inspection and/or test status is suitably identified throughout the production process. (I.4.12.1) |
| 2. | If required by the customer, additional verification requirements are met for launching of new |
| | products. (I.4.12.2) |

4.13 CONTROL OF NONCONFORMING PRODUCTS

| | |
|---|---|
| 1. | Systems ensure identification, documentation, segregation (where possible) to a designated |
| | area, and disposition of nonconforming and suspect product. (I.4.13.1) |
| 2. | Responsibilities for review and disposition of nonconforming and suspect product are clearly |
| | defined. (I.4.13.2) |
| 3. | Nonconforming and suspect products are reviewed according to defined procedures. |
| | (I.4.13.2) |
| 4.1 | Systems ensure nonconforming and suspect parts are reviewed to specified requirements. |
| | (I.4.13.2) |
| 4.2 | Systems ensure nonconforming and suspect parts are accepted with customer-approved |
| | concessions (EAPAs). (I.4.13.2) |
| 4.3 | Systems ensure nonconforming and suspect parts are reworked to approved repair |
| | standards. (I.4.13.2) |
| 4.4 | Systems ensure nonconforming and suspect parts are regraded for alternative applications. |
| | (I.4.13.2) |
| 4.5 | Systems ensure nonconforming and suspect parts are rejected or scrapped. (I.4.13.2) |
| 5. | Processes assure that only material that has passed inspections and/or tests can be provided |
| | to the customer. (I.4.13.2) |
| 6. | Nonconformances are recorded to permit defect analysis. (I.4.13.3) |
| 7. | Reworked products are reinspected and/or tested according to the Control Plan. (I.4.13.2) |
| 8. | Repair/rework instructions are accessible and utilized by the appropriate personnel. (I.4.13.3) |
| 9. | Where applicable, approvals are obtained for products supplied for service applications that |
| | may have visible rework. (I.4.13.3) |
| 10. | Systems ensure that customer authorization is received prior to shipping nonconforming |
| | material. (I.4.13.4) |
| 11. | Records are maintained of the expiration dates for engineering approved product |
| | authorizations (EAPAs) and quantities authorized. (I.4.13.4) |

4.14 CORRECTIVE AND PREVENTIVE ACTION

| | |
|---|---|
| 1. | Appropriate corrective actions are developed to eliminate causes of nonconformances? |
| | (I.4.14.2.c) |
| 2. | Disciplined problem solving methods are used. (I.4.14.1) |
| 3. | Customer complaints and reports of nonconformances are effectively handled. (I.4.14.2.a) |
| 4. | Causes of nonconformances are investigated and the results documented. (I.4.14.2.b) |
| 5. | Effectiveness of corrective action is verified. (I.4.14.2.d) |
| 6. | Returned parts from customer's locations are analyzed and corrective actions are initiated. |
| | (I.4.14.2) |
| 7. | Nonconformance reports, (e.g. product quality, deviation, audit result, quality records, etc.) are |
| | used to develop preventive actions. (I.4.14.3.a) |
| 8. | Relevant information on actions taken including changes to procedure are submitted for |
| | management review. (I.4.14.3.d) |

4.15 HANDLING, STORAGE, PACKAGING, PRESERVATION AND DELIVERY

| | |
|---|---|
| 1. | Material handling methods prevent product damage and deterioration. (I.4.15.2) |
| 2. | Storage areas are appropriate for preventing damage or deterioration of the product. (I.4.15.3) |
| 3. | When required by the nature of the product, the condition of product in stock is checked at |
| | intervals to detect deterioration. (I.4.15.3) |
| 4. | Systems control the packing, packaging, and marking processes to the extent necessary to |
| | ensure product conformance to specifications. (I.4.15.4) |
| 5. | Applicable customer packaging standards are available. (I.4.15.4) |
| 6. | Compliance to applicable customer packaging standards. (I.4.15.4) |
| 7. | Appropriate methods are used for product preservation and segregation. (I.4.15.5) |
| 8. | Systems ensure the protection of product quality during delivery to the destination. (I.4.15.6) |
| 9. | Appropriate analyses and corrective actions are used when scheduled delivery performance is |
| | not 100%. (I.4.15.6) |
| 10. | Inventory management system optimizes inventory turns and stock rotation. (I.4.15.6) |

4.16 CONTROL OF QUALITY RECORDS

| | |
|---|---|
| 1. | Records show effective operation of the quality system, including pertinent sub-contractor |
| | quality records. (I.4.16) |
| 2. | Quality records are legible and readily retrievable. (I.4.16) |
| 3. | Quality records (hardcopy or electronic) are stored in a suitable environment to prevent |
| | deterioration, damage, or loss. (I.4.16) |
| 4.1 | Quality records are retained per established procedures. (I.4.16) |
| 4.2 | Quality records include production part approval, control charts, internal quality audits, and |
| | failure mode and effects analysis (FMEAs). (I,4,16) |
| 5. | Quality records are available to the customer. (I.4.16) |
| 6. | Systems ensure retention control and timely disposal of quality records. (I.4.16) |

4.17 INTERNAL QUALITY AUDITS

| | |
|---|---|
| 1. | Internal quality system audits are conducted as planned. (I.4.17) |
| 2. | Personnel conducting the audit are independent of the function being audited. (I.4.17) |
| 3. | Audits are scheduled on the basis of the status and importance of the activity. (I.4.17) |
| 4. | Audit results are documented and brought to the attention of the responsible personnel. |
| | (I.4.17) |
| 5. | Corrective actions are timely, recorded, and evaluated for effectiveness. (I.4.17) |
| 6. | Audits include work environment and general housekeeping. (I.4.17) |

4.18 TRAINING

| | |
|---|---|
| 1. | Training needs for all personnel performing activities affecting quality are met. (I.4.18) |
| 2. | Qualifications for jobs affecting quality include identification of appropriate education, training |
| | needs, and experience. (I.4.18) |
| 3. | Training records are maintained. (I.4.18) |
| 4. | Training effectiveness is periodically evaluated. (I.4.18) |

4.19 SERVICING

| | |
|---|---|
| 1. | Servicing meets the specified requirements. (I.4.19) |
| 2. | Reporting and verification systems are established to communicate data from servicing |
| | functions to supplier manufacturing, engineering and design activities. (I.4.19) |

4.20 STATISTICAL TECHNIQUES

| | |
|---|---|
| 1. | Need of statistical techniques for establishing, controlling, and verifying the capability of |
| | process parameters and product characteristics has been identified. (I.4.20.1) |
| 2. | Procedures are established and maintained to implement and control the application of |
| | statistical techniques. (I.4.20.2) |
| 3. | Advanced quality planning is used to determine the appropriate statistical techniques. |
| | (I.4.20.2) |
| 4. | Concepts of variation, control (stability), capability, and over-control are understood |
| | throughout the organization. (I.4.20.2) |

II.1 PRODUCTION PART APPROVAL PROCESS

| | |
|---|---|
| 1. | Complete supporting data exists for all production part approval submissions. |
| 2. | Supporting data shows conformance to all customer requirements, including change |
| | notification. (I.4.9.6,II.1) |
| 3. | Supporting data is organized and filed together for each part. |
| 4. | Materials are purchased from customer approved subcontractor list. (I.4.6.1) |

II.2 CONTINUOUS IMPROVEMENT

| | |
|---|---|
| 1. | Continuous quality and productivity improvement efforts are a key element of the company's |
| | business. |
| 2. | Specific improvement projects have been identified. |
| 3. | Appropriate measurables are identified for improvement projects. |
| 4. | Evidence of improvement in project measurables exists over relevant time periods (from six |
| | months to five years). |

II.3 MANUFACTURING CAPABILITIES

| | |
|---|---|
| 1. | Cross-functional teams are used for facilities, equipment, and process planning in conjunction |
| | with the advanced quality planning process. |
| 2. | Plant layout minimizes material travel and handling, facilitating synchronous material flow, and |
| | maximizing value added use of floor space. |
| 3. | Mistake proofing techniques are utilized where appropriate. |
| 4. | Resources are available for tool and gage design (If subcontracted, rate the tracking and |
| | follow-up system). |
| 5. | Resources are available for tool and gage fabrication (If subcontracted, rate the tracking and |
| | follow-up system). |
| 6. | Resources are available for complete tool and gage dimensional inspection (If subcontracted, |
| | rate the tracking and follow-up system). |
| 7. | Resources are available for tool and gage maintenance and repair (If subcontracted, rate the |
| | tracking and follow-up system). |

In an embodiment, a system may identify and quantify critical path dependencies and depict critical nodes as assets and links in the chain as the critical path. In one embodiment, a system performs the following steps: 1) Identifying critical DIE Assets and their vulnerabilities related to critical path dependencies on commercial infrastructure, 2) Establishing the supply chain dependency and supporting infrastructure that depict critical nodes and links in the critical path, 3) Performing analysis of key nodes and determining threats to commercial assets, vulnerabilities, and impacts of disruption, 4) Identifying and determining essential business processes within the dependency chain that may be at risk including potential disconnects, bottlenecks, shortcomings in delivery and distribution, product/component delays, production disruption impacts, and 5) Recommending mitigation options and remediation actions in order to assist decision maker with corrective actions, improvements or efficient enhancements to mission essential assets that further the objectives of infrastructure assurance.

In an embodiment, the system assesses sites located anywhere in the world—including private sector organizations (e.g., suppliers, subcontractors, and commercial infrastructure providers, service providers, etc.), public sector organizations (e.g., suppliers, subcontractors, and commercial infrastructure providers, service providers, etc.), government/state/local facilities, and Combatant Commands (COCOMs).

The scheduling of a site assessment is referred to as an “event”. An event may include a single assessment or multiple assessments that begin on the same scheduled date. Events may terminate when a date, after the scheduled start date, has been reached, or, when a designated site has completed the assessment process, or, which ever occurs first. Embodied with this method and apparatus may be an Event Management System, or Event Manager. The Event Manager may work in coordination with the Notification System, but can also function as a stand-alone embodiment. The Event Manager has the ability to schedule, coordinate, and automatically manage events. There are, at least, two key factors the Event Manager must consider in planning an Event: “bandwidth” and “rate of deployment”. Bandwidth is the number of Sites to be assessed per Event and can be represented as the Y-axis on a Cartesian coordinate table. Rate of Deployment is the speed at which the Assessment Even™ occurs and represents the X-axis on the same Cartesian coordinate table. Rates of Deployment can range from: 1) a single Site assessment Event, to 2) one or more subsequent phased events, through 3) dynamic, self-generating, automatic deployment of assessments.

In an embodiment, a system may provide valuable pre-assessment information to government agencies identifying vulnerabilities and susceptibilities of a Site to natural disasters or man-made threats, critical path dependencies within supply chains and supporting infrastructures that depict critical nodes as assets and links in the chain as the critical path. In some embodiments, this information can then be triaged to other agencies, such as the National Guard Bureau, making on-site examinations more efficient and effective. In certain embodiments, the system may be used to assess the security of designated sites in all U.S.-government defined critical infrastructures.

In an embodiment, a system may be used to perform risk analysis (assessment of a threat, exploiting a vulnerability, causing harm to an asset) of key nodes and systems within the commercial assets supply chain and infrastructure to determine threats to commercial assets, vulnerabilities and impacts of disruption.

In an embodiment, a system may be used to identify and determine where essential business processes within the chain may be at risk, determine threats and susceptibilities that influence the supply chain, core production processes, and supporting business processes. In some embodiments, the system may identify potential disconnects, bottlenecks, shortcomings in delivery and distribution, product/component delays, and production disruption impacts.

In an embodiment, a system may assist decision-makers with corrective actions, identify improvements, efficiency enhancements, or remediation to mission essential assets that further the objectives of infrastructure assurance to promote systems reliability, readiness and continuity of operations. In one embodiment, the system may use Correct Measures™ technology marketed by iMet Laboratories.

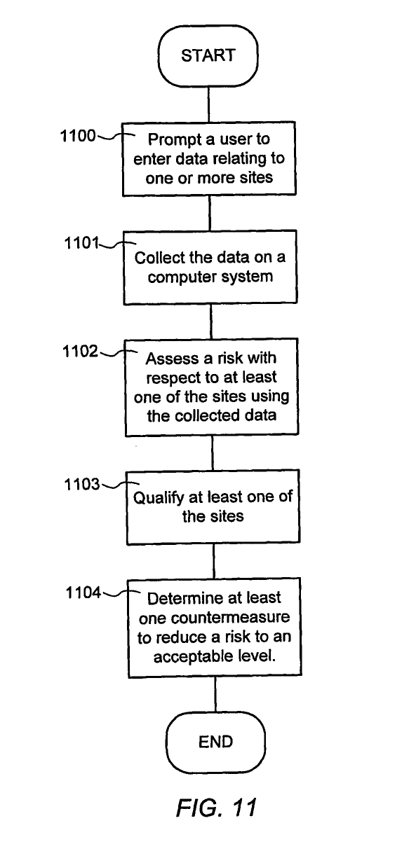

FIG. 11 depicts one embodiment of a method of using a computer system to assess risk. In step 1100, the system prompts a user to enter data about one or more sites. In step 1101, the data entered by the user is collected on a computer system. In step 1102, the system assesses a risk with respect to the sites using the data collected in step 1101. In step 1103, the system qualifies one or more of the sites. In step 1104, the system determines one or more countermeasures to reduce a risk to an acceptable level.

In some embodiments, a system may provide an intelligent viewing utility that enables customers to view data transferred from the method and apparatus described herein. In certain embodiments, the system may perform the following functions:
1. Ability to view data transfers from one system to another in an easy to understand, graphical representation.
2. Upon the conclusion of each event, automatically generation of a prioritization list of all assets (sites) assessed for customer.
3. Update and prioritize the list of the assets at the close of each event.
4. Allow a customer to select from several, preprogrammed queries and sort methodologies that will provide basic, real-time data manipulation such as all levels assessed to date, critical infrastructures, vulnerabilities, impact if loss of supporting infrastructure, etc.

In an embodiment, a method for implementing an assessment may include the following steps:
Create a critical infrastructures/vulnerability module (DoD Module)
Receive and integrate an electronic list of DIB sites from a customer
Assure designated DIE sites are informed of a customer's program intent
Administer its assessment to the designated sites by providing web-based access and controls to a DIB site
Allow the sites to complete the assessment within a designated time period (e.g., 30 calendar days)
Provide Event Management/customer support
Process data and Return results to Customer

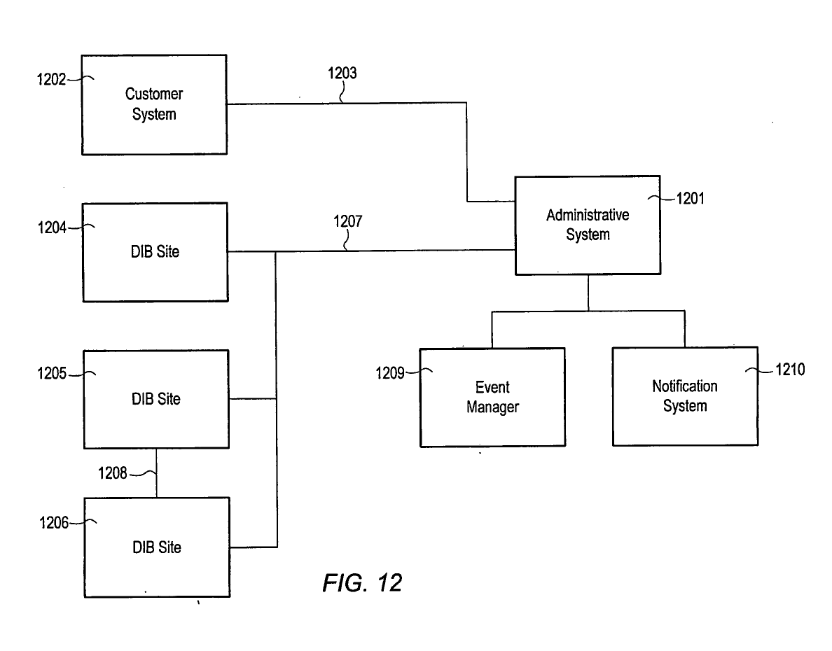

FIG. 12 depicts an administrative system for assessing risk of a number of sites for a customer. Administrative system 1201 may be coupled to customer system 1202 through network connection 1203. Administrative system 1201 may be coupled to DIB sites 1204, 1205, and 1206 through network connection 1207. In some embodiments, two or more sites may be dependent on one another. For example, DIB site 1206 may be a supplier to DIB site 1205. In certain embodiments, a network connection may be provided between sites. For example, DIB site 1205 may be connected to DIB site 1206 through network connection 1208. DIB sites 1204, 1205, and 1206 and customer system 1202 may each be in a remote location from administrative system 1201. In certain embodiments, network connections 1207 for each of DIB sites 1204, 1205, and 1206 are separate from the network connections for other DIB sites. In other embodiments, network connection 1207 for all the DIB sites are provided over a common network. In one embodiment, one or both of network connections 1203 and 1207 are provided over a secure internet connection. In some embodiments, administrative system 1201 may be operated by a service provider of customer at the service provider's facility. Administrative system 1201 may include event manager 1209 and notification system 1210. Event manager 1209 may schedule and manage events relating to risk assessment of the sites. Notification system 1210 may notify a site that an action by the site is required within a prescribed timeline (e.g., before the last day of an event).

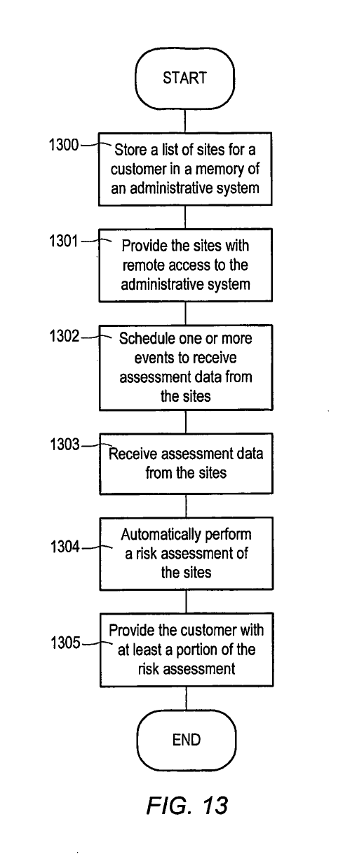

FIG. 13 depicts an embodiment of a method of assessing risk for a customer. In step 1300, a list of sites of interest to a customer is stored in a memory of an administrative system. In some embodiments, the list may be an electronic list electronically transmitted to a service provider by its customer. In step 1301, the sites are provided with remote access to the administrative system. In step 1302, one or more events are scheduled. The scheduled events may be automatically coordinated and managed by an event manager. In step 1303, the administrative system may receive assessment data from the sites. In step 1304, the administrative system may automatically perform a risk assessment of the sites. In step 1305, the administrative system may provide the risk assessment to the customer.

In one embodiment, steps for implementing and using a program plan for assessing risk may include the following:

| Step | Description |
|---|---|
| 1 | Provide list of DIBs to administrative organization |
| 2 | Setup assessment system; establish deployment campaign and |
| | Event Schedule |
| 3 | Deploy assessments in accordance with the Event schedule |
| 4 | Provide helpdesk assistance to Sites and ensure completion on |
| | schedule |
| 5 | Process data from each event |
| 6 | Review/evaluate results |
| 7 | Transfer processed data from administrative organization to |
| | Customer's database |
| 8 | Customer determines appropriate follow-up actions: |
| | Continue with Event schedule C, D, E, & F. |
| | Repeat Step 1-8. |

In some embodiments, customers may have several hundred thousand sites that require assessing. To facilitate the organization of these many sites into more manageable groupings, sites may be divided into “blocks”. The following is a typical block designator table:

| Block | |
|---|---|
| Designator | Description |
| A | Internal Calibration Phase |
| B | 1,000 initial key Sites identified by customer |
| C | Reserved for 2^{nd} grouping of Sites (e.g., 100,000) |
| D | Reserved for 3^{rd} grouping of Sites (e.g., 100,000) |
| E | Reserved for 4^{th} grouping of Sites (e.g., 100,000) |
| F | Reserved for 5^{th} grouping of Sites (e.g., 100,000) |
| Ongoing | If a block groupings exceed single letter alpha characters, |
| | a block designation lettering will continue with AA-AZ, |
| | BA-BZ, etc. |

In some embodiments, a block of sites may require multiple levels of assessments. Each level of assessment may be considered an “event”. Each block may have infinite number of events. Events may be bundled groups of assessments. In one embodiment, a designation of block and events may be as follows:

Block Event Table

| | | | |
|---|---|---|---|
| | | | Estimated |
| Block | Event | Description | Quantity |

| | | |
|---|---|---|
| A | 1 | Internal calibration |
| B | 1 up to 7 | 1,000 Key Sites identified by customer |
| | | and subsequent levels |
| C | 1 up to 7 | Reserved for 2^{nd} grouping of Sites |
| | | and subsequent levels |
| D | 1 up to 7 | Reserved for 3^{rd} grouping of Sites |
| | | and subsequent levels |
| E | 1 up to 7 | Reserved for 4^{th} grouping of Sites |
| | | and subsequent levels |

In some embodiments, an administrative organization may license access to an assessment system. Licenses may allow a customer or end user to access a site and participate in assessment events. In certain embodiments, a customer license may allow a customer to view, manipulate and retain data analysis derived from ongoing events and provide a collection mechanism to pass state information for sites. In certain embodiments, end user licenses may be electronic tickets (E-tickets) that enable a designated site (or “Asset”, as the Government refers to them) to access and participate in an assessment event. End-User Licenses may be sold by event and bundled (e.g., in sizes of 100, 250, 500, and 1,000).

In an embodiment, a method for assessing criticality, vulnerability, and risk may include one or more of the following steps:
1. Site Identification
2. Defense Industrial Base (DIB) Identification
3. Site Qualification
4. Site Valuation
5. Interdependency Identification
6. Asset Identification and Qualification
7. Asset Valuation
8. Potential Threat Identification
9. Severity of Threat Analysis
10. Criticality Rating Assignment
11. Vulnerability Rating
12. Terrorist View
13. Determine Risk Level
14. Corrective Actions
15. Mitigation/Protection Plans
16. Cost Benefit Analysis
17. Review and Implementation
   A system used in performing the assessment may be referred to herein as a “CVR administrator”. As used herein, “site” generally includes any site, facility, location, or a combination of one or more of these. “Assets” may include, but are not limited to, any assets, personnel, processes, facilities, functions, equipment, systems, operations, data, or procedures.

### Site Identification

In an embodiment, a CVR administrator may start with the identification of one or more sites. The CVR administrator may assign unique identification labels to each site, which may be stored with a database. The CVR administrator may use a variety of methods to uniquely identify each site, such as physical address, phone number, website address, etc. The CVR administrator anticipates each site to have one or more “assets”, which include personnel, equipment, systems, operations, data, and procedures. The CVR administrator also considers assets value can be quantified in terms of dollars or any other denomination. The CVR administrator creates an unlimited relationship in the database between sites and assets. Assets may have assets, and the process can cascade indefinitely and is only limited by the size of the design capacity of the database used and selected storage media.

One or more site names and related information, such as physical address, city, state, zip, phone, contact person, etc. may be input into the CVR administrator. This information, referred to as site data, can be accessed by system administrators for modification, deletion, correction, and otherwise manipulated as needed.

In an embodiment, empirical data captured during an assessment process is used to determine the ratio of number of product/service suppliers and the number of critical infrastructure suppliers per level.

In an embodiment, a system may enforce rules of engagement in deploying for making risk assessments at a plurality of sites. In one embodiment, a single administrative organization may administer assessments relating to specific sites designated by a customer. In one embodiment, the assessments may be made using Scientific Assessment™ technology marketed by iMet Laboratories. The administrative organization may create, coordinate, ship, administer and control an assessment operation on behalf of the customer. Each assessment may be site-specific.

In some embodiments, the administrative organization may administer assessments to a group of designated sites as a scheduled event. Each event may have a published start and absolute finish date. A customer may be responsible for managing participation by the individual sites. Each site's personnel may be responsible for completing the site's own assessments within the event schedule defined by the Customer and published by an administrative organization. Extensions are may be treated as exceptions to the event schedule.

In some embodiments, the administrative organization may retain all raw data collected from each specified site for the administrative organization's or customer's continued use in the administrative organization's knowledge engine. The raw data may further be used to provide ongoing modeling capability to the customer. Composite data may be processed, handled and delivered in accordance with the customer's contract. In certain embodiments, the administrative organization may assist, direct, and provide a help desk or other technical support to the sites in the making assessments.

In an embodiment, a CVR administrator may determine the percentage of commercial and defense work performed at a site.

In an embodiment, a CVR administrator may capture information pertinent to a site's entire facility (e.g., all of the buildings at a facility) rather than work performed at one or more buildings at the facility.

In an embodiment, a system may include an intelligent viewing utility that enables customers to view data collected by, stored in, or transferred from the system described herein.

### Defense Industrial Base (DIB) Identification

Certain sites within the United States and abroad provide products to the U.S. Department of Defense. These sites are considered “Defense Industrial Base Suppliers”, or “DIBs”. In some embodiments, the CVR administrator may determine, when assessing a site, if the site is a DIB. A sample question presented to a senior official at a site might be: “Which of the following best describes your organization:” The users options may be: 1) This site does not provide products or services to the U.S. DoD, 2) This site currently provides products or services to the U.S. DoD, 3) This site does not currently provide products or services to the U.S DoD, but has in the past, 4) This site does not currently, but is pursuing contracts to provide products or services to the U.S. DoD. The CVR administrator may return a value for each selected response. For example, the response returns a value equal to it identification number (e.g., the first response returning a value of “1”). In the above example, since a site responding with a value of “1” does not provide parts or services to our Government, based upon business rules, the system may to terminate further questioning regarding investigating DoD support and take the user to another part of the program. Alternatively, option #3 (parts or services were formerly provided) may result in the CVR administrator presenting a select group of related questions to further investigate and record relevant information. Option #4 may result in the CVR administrator presenting a series of questions that provide the receiver of the data (i.e., customer) resulting in the further pre-qualification of the site and/or forewarning of certain issues that could arise should the site actually receive a government-related contract.

Selection of option #2 may result in the CVR administrator presenting the user with additional questions to further qualify the site. The questions may be based upon current pre-programmed business rules, by rules self-learned from the response data by applying neuro-logic applications, or a combination of both.

### Site Qualification

Once a site has been identified, the site, including any or all of its assets, may be quantified to develop a true perspective regarding criticality, vulnerability and impact if lost. In an embodiment, a CVR administrator may “qualify” the site to determine the impact to the government, state and any of its agencies, commercially, or to the local economy if the site were lost. This stage of the process may also consider any potential loss of life and assigns it a value, such as $2.7 million per life.

The CVR administrator may present a series of questions to the user. In one embodiment, questions may be based on Section 1016. Critical Infrastructures Protection, Critical Infrastructure. The user can identify whether the loss of the site (including its systems and assets, whether physical or virtual), are so vital to the United States that the incapacity or destruction of such systems and assets would have a debilitating impact on security, national economic security, national public health or safety, or any combination of those matters. The user may be provided with a variety of response mechanisms that would allow the user to only respond in a yes/no/don't know binary fashion, or 0-100 sliding scale that could include prompts to help the user in its response. The weighting associated to the user's select answer may be stored in the database for future calculations. Based upon factors including, but not limited to, 1) one or more business rules designed into the CVR administrator, 2) dynamic calculations interacting with the business rules, or 3) derived calculations that modify the business rules, the CVR administrator may compare the user's selected values to those defined within its rule base and then elect to allow the user to continue and further query for additional supporting and verifying information or take the user to a different section of the assessment program.

From a list such as one provided by the U.S Department of Homeland Security (e.g., Homeland Security Presidential Directive/Hspd-7), a user may further define which critical infrastructures defined as agriculture, banking and finance, chemical industry, defense industrial base, emergency services, energy, food, government, info & telecom, postal and shipping, public health, transportation, and/or water, an organization or site supports. The user may be provided with a variety of response mechanisms that would allow the user to select or identify those applicable. The weighting associated to the select item may be stored in the database and used as a vector for future calculations and representation of the data in future reporting functions. Based upon factors including, but not limited to, 1) one or more business rules designed into the CVR administrator, 2) dynamic calculations interacting with the business rules, or 3) derived calculations that modify the business rules, the system may compare a user's selected values to those defined within its rule base and then elect to allow the user to continue and further query for additional supporting and verifying information, or may take the user to a different section of the assessment program.

### Site Valuation

In an embodiment, information gathering system 212, and in conjunction with the CVR administrator to determine “valuation” of the site, may operate in conjunction with a database of questions stored in the memory 110 of the computer 100 to generate at least a portion of a set of questions to be provided to a human assessor. Questions stored within memory 110 may be identified as directed to various standards, such as U.S. Department of Homeland Defense HLS-CAM, or specific in nature and designed to ascertain the related information. Through a series of questions presented to the user, the CVR administrator may, by a means of selection, textual input, or combinations of both, identify the impact to 1) national security, 2) public health and safety, 3) economic impact, 4) catastrophic loss of life, and 5) iconic symbolic value, or 6) other impacts. Based upon factors including, but not limited to, 1) one or more business rules designed into the CVR administrator, 2) dynamic calculations interacting with the business rules, or 3) derived calculations that modify the business rules, the system may compare the user's selected values to those defined within its rule base and then elect to allow the user to continue and further query for additional supporting and verifying information, or, in the alternative, elect to take the user to a different section of the assessment program.

For example, relative to national security, the CVR administrator may present the user with the question: “The loss or degradation of this site, facility, asset, activity, process, (etc) would impact which of the following: 1) the security of the United States, 2) the security of a State, 3) Region within a State, and/or 4) City, County, or local area?” Based upon the answer, the user could be provided additional questions querying them to input the exact impact, state affected, etc. The weighting associated to the select item may be stored in the database and used as a vector for future calculations and representation of the data in future reporting functions. The system may compare the user's selected values to those defined within its rule base and then elect to allow the user to continue and further query for additional supporting and verifying information, or, in the alternative, elect to take the user to a different section of the assessment program.

Relative to public health and safety, the CVR administrator may, for example, present the user with the question: “What potential hazardous threat to public health and/or safety could this site, facility, asset, activity pose if it were attacked or had a serious accident?” Based upon the user's response, the CVR administrator could provide the user with additional questions querying them to select, identify, input, etc. the exact nature of the impact. The weighting associated to the select item may be stored in the database and used as a vector for future calculations and representation of the data in future reporting functions. Based upon factors including, but not limited to, 1) one or more business rules designed into the CVR administrator, 2) dynamic calculations interacting with the business rules, or 3) derived calculations that modify the business rules, the system may compare the user's selected values to those defined within its rule base and then elect to allow the user to continue and further query for additional supporting and verifying information, or, in the alternative, elect to take the user to a different section of the assessment program.

Relative to economic impact, the CVR administrator could, for example, present the user with the question: “What would be the economic impact on the United States from the loss or degradation of this site, facility, asset, activity, process, (etc.)?” Based upon the user's response, the CVR administrator could provide the user with additional questions querying them to select, identify, input, etc. the exact nature of the impact to public health and safety. The weighting associated to the select item may be stored in the database and used as a vector for future calculations and representation of the data in future reporting functions. Based upon factors including, but not limited to, 1) one or more business rules designed into the CVR administrator, 2) dynamic calculations interacting with the business rules, or 3) derived calculations that modify the business rules, the system may compare the user's selected values to those defined within its rule base and then elect to allow the user to continue and further query for additional supporting and verifying information, or, in the alternative, elect to take the user to a different section of the assessment program.

Relative to catastrophic loss of life, the CVR administrator could, for example, present the user with the question: “Based upon the population of people within this facility and surrounding area to what degree could there be catastrophic loss of life or injury?” The user could be presented with a sliding bar display device with vectors each end identified as “None” to “Catastrophic”. In the alternative, the user could be requested to select from a pre-defined menu of values, input textual information, numbers, etc. Furthermore, the user could be asked, for example, “Loss of life would be limited to which of the following: 1) No impact, 2) Small area within facility, 3) Entire facility, 4) Facility and small area outside, 5) Surrounding neighborhood, 6) County, 7) State or Region, 8) Section of the Country, 9) National, and 10) Global.” Based upon the user's response, the CVR administrator could provide the user with additional questions querying them to select, identify, input, etc. the exact nature of the impact. The weighting associated to the select item may be stored in the database and used as a vector for future calculations and representation of the data in future reporting functions. Based upon factors including, but not limited to, 1) one or more business rules designed into the CVR administrator, 2) dynamic calculations interacting with the business rules, or 3) derived calculations that modify the business rules, the system may compare the user's selected values to those defined within its rule base and then elect to allow the user to continue and further query for additional supporting and verifying information, or, in the alternative, elect to take the user to a different section of the assessment program.

Relative to iconic value, the CVR administrator could, for example, present the user with the question: “To what degree does this site represent an icon that would provide political, financial, historical, entertainment, or similar value?” The user could be presented with a sliding bar display device with vectors each end identified as “None” to “Catastrophic”. In the alternative, the user could be requested to select from a pre-defined menu of values, input textual information, numbers, etc. Furthermore, the user could be asked, for example, “Loss of life would be limited to which of the following: 1) No impact, 2) Small area within facility, 3) Entire facility, 4) Facility and small area outside, 5) Surrounding neighborhood, 6) County, 7) State or Region, 8) Section of the Country, 9) National, and 10) Global.” Based upon the user's response, the CVR administrator could provide the user with additional questions querying them to select, identify, input, etc. the exact nature of the impact. The weighting associated to the select item may be stored in the database and used as a vector for future calculations and representation of the data in future reporting functions. The system may compare the user's selected values to those defined within its rule base and then elect to allow the user to continue and further query for additional supporting and verifying information, or, in the alternative, elect to take the user to a different section of the assessment program. Based upon factors including, but not limited to, 1) one or more business rules designed into the CVR administrator, 2) dynamic calculations interacting with the business rules, or 3) derived calculations that modify the business rules, the system may compare the user's selected values to those defined within its rule base and then elect to allow the user to continue and further query for additional supporting and verifying information, or, in the alternative, elect to take the user to a different section of the assessment program.

Relative to other impacts, the CVR administrator could, for example, present the user with the question: “What are other reasons that would make this site, facility, asset, activity, process, etc. a potential target?” Based upon the user's response, the CVR administrator could provide the user with additional questions querying them to select, identify, input, etc. the exact nature of the impact. The weighting associated to the select item may be stored in the database and used as a vector for future calculations and representation of the data in future reporting functions. Based upon factors including, but not limited to: 1) one or more business rules designed into the CVR administrator, 2) through dynamic calculations interacting with the business rules, or 3) derived calculations that modify the business rules, the system could compare the user's selected values to those defined within its rule base and then elect to allow the user to continue and further query for additional supporting and verifying information, or, in the alternative, elect to take the user to a different section of the assessment program.

Based upon the previous provided responses relative to impact, the CVR administrator may present the user with additional questions to determine the type of losses that could result. The system may present a series of questions that could interact with the user to determine: 1) delays and denial of service/data integrity or malfunction, 2) health and safety; loss of life, 3) incapacitation or injury, impact to the environment, disruption to the continuity of operations, 4) impact to regulatory and contractual obligations which could result in law suits, 5) disclosure of proprietary information, impact to reputations, 6) credibility, confidence and loyalties, 7) related direct losses and recovery costs, 8) impact to the site's economic/financial condition; reduction in its return on investments, and 9) loss of market share; lost business opportunities. Based upon factors including, but not limited to: 1) one or more business rules designed into the CVR administrator, 2) through dynamic calculations interacting with the business rules, or 3) derived calculations that modify the business rules, the system could compare the user's selected values to those defined within its rule base and then elect to allow the user to continue and further query for additional supporting and verifying information, or, in the alternative, elect to take the user to a different section of the assessment program.

In some embodiments, a CVR administrator may present a user with one or more questions to determine the severity of the impact. For example, a question presented to the user might be “This site could impact:”.The response mechanism displayed could be a sliding bar display with textual prompts. As the user slides the bar, for example, from left to right, text appearing around the bar could display “national or catastrophic loss of life”, “Impact to Regional or State”, or “Regional, City/County/local area”. Although only three different options were presented to the user, their movement through each could produce a 0-33, 34-66, 67-100 respective score to the CVR administrator. Based upon factors including, but not limited to: 1) one or more business rules designed into the CVR administrator, 2) dynamic calculations interacting with the business rules, or 3) derived calculations that modify the business rules, the system could compare the user's selected values to those defined within its rule base and then elect to allow the user to continue and further query for additional supporting and verifying information, or, in the alternative, elect to take the user to a different section of the assessment program. The weighting associated to the select item may be stored in the database and used as a vector for future calculations and representation of the data in subsequent reporting functions.

Upon completion of the site valuation section by the user, the CVR Administrator may conduct a series of calculations to determine the impact on the loss of the site/asset to 1) national security, 2) the types of losses that may occur, and 3) whether the impact will affect the nation, a state, region, or local area. The results and associated vectors may setup two- or three-dimensional graphs depicting the site/Assets value as a potential target.

### Interdependency Identification

Sites depend upon other organizations to provide products and/or services so the site can fulfill its mission. Manufacturers rely on other companies (suppliers) to provide parts and raw materials. Organizations providing service and maintenance, typically also rely on parts from suppliers and even the larger manufacturers. Virtually every organization relies on infrastructure providers to provide electricity, water, communications/data, natural gas and petroleum/oil/lubricants (POL). Providers in these of vital interdependencies may be referred to as “critical infrastructure providers.” In one embodiment, identification of such providers may be performed using Dependency Chain™ marketed by iMet Laboratories.

In an embodiment, the CVR administrator may identify and determine a mission/task/requirement for the site or “Installation”, and subsequently, each of its associated assets. Through the use of a relational database for providing the query format and storing the results, the CVR administrator may determine and capture information regarding: 1) name site/Installation, 2) Mission Required Assets, 3) Infrastructure Support Assets, 4) Installation Assets, and 5) Commercial Infrastructure Assets. This may be accomplished by many of the same techniques described herein such as user selection via pull-down menus, checkboxes, radio button selection, or text fill-in. Information may be collected for each subcontractor, service- or critical infrastructure provider a site depends on to fulfill its mission.

### Asset Identification and Qualification

Once identified, a user may be asked to identify each Mission Required Asset (MRA). The CVR administrator may query the user(s) of each asset to determine the components of the asset comprised of facilities, function, people and process. Each captured piece of information may be stored by the CVR administrator in a relational database. The CVR administrator may then determine what percentage of the mission/task/requirement is being provided by each identified asset. Through a series of additional questions, the CVR administrator may query the user to determine single point failure and link and impact analysis to critical nodes (the smallest part of an infrastructure that can still execute its critical function). For example, a coal/gas powered generating plant can lose its rail-lines supplying coal and still generate electricity. The critical node may become the gas-powered boilers and generators.

A CVR administrator may further query users to determine if the asset has excess capacity and if there are other demands for the access capacity and time constraints. For example, the manufacturing process for a single product may require 75% of the Installation's inlet supply of natural gas for a single-shift 8-hour duration. The remaining 25% may be sufficient to heat the facility during the day time but at night 50% of the Installation's natural gas must be used to heat the facility. If the government demands the increase production of additional products requiring similar natural gas consumption, the Installation will have a constraint. In this example, the CVR administrator would identify and record that the natural gas supplier is a critical link in the process and a “Commercial Infrastructure Asset”. The CVR administrator may require the users to input the name and associated information (i.e. address, city, state, zip, contact, etc) of the Commercial Infrastructure Asset. This information may be stored in a database and will be used by the system to trigger a subsequent assessment of the natural gas provider's installation.

### Asset Valuation

In some embodiments, a CVR administrator may implement a process to identify, qualify and prioritize any potential asset within site and assign it an asset valuation. To do so, the system may present the user with a series of questions that enable the system to determine the total valuation of the site and each identified asset. The system may query the users to determine the total number of employees and the total value of all physical assets. The system may further query the total valuation of the entire site, excluding personnel, if lost to a catastrophic event. Relative to individual assets, the system may query the cost of initial asset, the cost of temporary substitute, the cost of permanent replacement, the cost of systems related to asset (For example, using the previous generator plant scenarios, a terrorist act against the generator would most likely also damage the building enclosing the unit. The building, electrical connections, plumbing, etc. are the related systems to the asset). The system may also query and record the potential number of injuries and/or lives that could be lost if the asset were lost in a catastrophic event.

In an embodiment, a CVR administrator may perform an assessment using multiple variables, such as probability, forewarning, onset speed, exposure, duration, impact as well as the U.S. Homeland Security Advisory System (HSAS). Used individually or in concert with each other, these variables may enable the CVR administrator, through the use of neuro programming and/or other artificial intelligence type of systems and programming, develop and present the user with scenarios that may identify when conditions and standards of the mission cannot be met.

In an embodiment, a CVR administrator may identify each subcontractor, service- or critical infrastructure provider a site depends upon to fulfill its mission. Subsequently, each identified interdependency may be evaluated to determine its importance to the site or installation. Through a series of gates and assigned weighting factors, the CVR administrator may assign and record in a database an overall importance weighting value for each asset.

In another embodiment, the CVR administrator may qualify each asset and assign a value based on its susceptibility to natural or man-made threats. A two dimensional Cartesian coordinate grid may be used to analyze and represent this function, where the levels of impairment or “Loss” is represented on the x-axis and the “Criticality” to fulfilling its mission is represented on the y-axis. The range for Loss is “Extreme” on the left side to “None” on the right. The range for Criticality are “Non-Critical” at the bottom to “Mission Critical” at the top.

In one embodiment, relative to Loss, there may be five (5) levels of recovery for Mission Critical: 1) Immediate recovery—where there is no down time allowed. This may require switching over to another source (i.e. power source from alternate provider or back-up generator). It may require switching to another already in-place site that is fully staffed and properly equipped. It may also mean that there is no immediate replacement, such as loss of the Golden Gate Bridge; 2) Up to 12 Hours—to recover and restore services. This may also require switching to another already in-place site that is fully staffed and properly equipped. However, several hours may be allowed to transfer data and/or personnel to bring the asset back on-line; 3) Up to 3 Days—to recover and restore services. This may also require switching to another site and physically moving or purchasing and reinstalling equipment to re-establish services; 4) 3-7 days recovery is a more extended version of the 3 day recovery. Similarly, it may require switching to another site and physically moving or purchasing and reinstalling equipment to re-establish services; 5) Up to 30 Day Recover—provides greater amount of time to switch to another site and physically moving or purchasing and reinstalling equipment before to re-establish of services.

Relative to Criticality, Mission Critical means that a site or installation cannot fulfill its mission or continue to function without this process. Important means the site can continue to operate with difficulty to fulfill its mission. In some cases, services may be degraded, but the asset continues to operate. Non-Critical means the site is inconvenienced but can continue operations and fulfill its mission.

In an embodiment, a CVR administrator may determine the importance of each asset to the site or installation. Through a series of gates and assigned weighting factors, the CVR administrator may assign and record in a database an overall criticality weighting value for each asset. Subsequently, the criticality weighting of each asset within a site may be used to mathematically derive at an overall criticality weighting value for the site.

### Potential Threat Identification

In another embodiment, a CVR administrator may identify, qualify and assign numeric values to the threats and potential hazards that could cause harm to the site, including assets, individuals, facility, or surrounding areas. In some embodiments, threats may be divided into the following four categories: 1) Natural, 2) Man-Made (includes Criminal/Terrorist), 3) Technical, and 4) Nation/State.

Natural threats are a major threat group that can be divided into three smaller groupings:
Geological Hazards: are typically considered costal erosion, earthquakes, glaciers, icebergs, landslides, mudslides, subsidence, tsunamis and volcanoes
Meteorological Hazards: are typically considered avalanches, droughts, dust/sand storms, extreme temperatures (heat/cold), famine, fires (forest, range, and urban), flash floods, floods, hail, hurricanes, ice, lightning strikes, seiche (resonant oscillation of the water), sleet, snow, tidal surges, tornados, tropical cyclones, water spouts, and windstorms
Biological Hazards: animal or insect infestations, diseases that impact humans and animals (plague, smallpox, anthrax, West Nile virus, foot and mouth disease), wild/poisonous animal attacks

Man-Made/(including Criminal/Terrorist) Threats primarily consists of bioterrorism, bomb-car, bomb-suicide, car bomb, chemical, chemical exposure, external, civil disturbance, communications failure, electrical failure, fire alarm failure, fire, internal, flood, internal, forensic admission, fuel shortage, generator failure, hostage situation, HVAC failure, infant abduction, information systems failure, infrastructure threats, labor action, large internal spill, mass casualty incident (medical/infectious), mass casualty incident (trauma), medical gas failure, medical vacuum failure, natural gas failure, radiological, radiological exposure, internal, sewer failure, small-medium sized internal spill, sniper, steam failure, supply shortage, transportation failure, VIP situation, and water failure.

Man-Made (including Criminal/Terrorist) Threats can be divided into the following two groups:
Accidental: building/structure collapse, communication systems interruption, contamination, economic depression, energy/power/utility/failure, explosion/fire, financial issues, financial system collapse, fuel/resource shortage, hazardous material (chemical, radiological, biological), inflation, spill or release, transportation accident, water control structure/dam/levee failure.
Intentional: arson, civil disturbance, crime (theft, murder, assault, etc.), electromagnetic pulse, enemy attack, espionage, insurrection, labor strike, mass hysteria, misinformation, public unrest, riot, terrorism (conventional, chemical, radiological, biological, cyber, use of advanced technologies) and war.

Technical threats may be comprised of circuit overloads, cyber, electrical interruptions, line breaks, short circuits, and transmission interruption.

Nation/State threats may be comprised of airborne, airplane, cruise missile, economic sanctions, missile, ship, torpedo, and waterborne attacks.

During the assessment process, the CVR administrator may query the user to the types of vulnerabilities the site is susceptibility to any or all of the types or threats. For Man-Made Threats, the system may further identify 1) errors caused by humans, 2) human errors due to judgment, 3) errors caused by insufficient or lack of proper training, 4) failure to follow procedures, 5) improper use or overloading of systems resulting in material failures, and/or 6) material failures.

In some embodiments, the CVR administrator may retrieve the first identified asset and present the user with a series of questions to determine the vulnerability to a particular threat. The system may repeat the process until all stored threats are exhausted, the user has provided additional threats and the associated comparison was completed, or, until the system has ascertained adequate information to recognize and determine the sites vulnerability. The system may loop in similar fashion through all previously identified assets. A two dimensional Cartesian coordinate grid may be used to analyze and represent this function, where “Threats” are represented on the x-axis and the “Vulnerability” to each is represented on the y-axis. The range for Threats is “None” on the left side to “Extreme” on the right. The range for Vulnerability is “None” at the bottom to “Catastrophic Failure” at the top.

Each threat may have a related damage mechanism associated with it. A certain threat may normally cause a certain type of damage. For example, severe cold often damages water supply pipes; hurricanes carry the associated damage mechanism of mechanical damage and transportation systems interruption. Damage mechanisms may be comprised of area/region annihilation, broadcast system restriction/shutdown, elimination/restriction of services, environmental contamination, environmental damage, information systems infection, information systems shutdown, injury/death, injury/death, loss/restriction of service, loss/restriction of service, loss/restriction of services, mass destruction, mechanical damage, telecommunication system shut down, and transportation systems interruptions. During the user's response phase, the CVR administrator may allow the user to identify certain damage mechanisms present a series

In an embodiment, the CVR administrator may determine the impact of a threat and corresponding vulnerability of each asset. Through a series of gates and assigned weighting factors, the CVR administrator may assign and record in a database an overall Potential Threat Identification weighting value for each asset. Subsequently, the vulnerability weighting of each asset within a site may be used to mathematically derive at an overall Potential Threat Identification weighting value for the site.

### Severity of Threat Analysis

In an embodiment, a CVR administrator may apply Threat Factors to provide an enhanced an accurate representation of the true vulnerability or a site. Threat Factors may include, but are not limited to, the following:
Probability: The likelihood threat will occur
Forewarning: The amount of time prior to the event in the way of a warning
Onset Speed: The amount of time that the event will present itself to site
Exposure: The period of time a potential threat poses a problem—such as always, at anytime, seasonal, etc.
Duration: Period of time threat can exist once present—such as 1 day, 5 days, forever, etc.
Impact: Impact of threat to site

In an embodiment, the CVR administrator may determine the Severity of a threat through the analysis of comparing the magnitude of the impact and how it may be reduced by mitigation efforts. For example, loss of electrical power by a hospital for more than one minute could result in a loss of life. As a result, a hospital could be considered highly vulnerable to loss or electrical power. However, most hospitals have back-up generator systems that provide emergency power in less than 30 seconds thereby mitigating the threat and making the threat negligible. The CVR administrator may administer questions to the user to further evaluate the severity a particular threat may pose. In a similar fashion, the CVR administrator may query users about the mitigation efforts in place to reduce the severity.

Threat Magnitude factors may be comprised, but not limited to, the following:
Human Impact: Possibility of death or injury
Property Impact: Physical losses and damages
Business Impact: Interruption of services

Threat Mitigation factors may include, but are not limited to, the following:
Preparedness: How well the site has recognized, anticipated, planned, and tested appropriate mitigation efforts
Internal Response: How quickly the site can respond, how effective is the mitigation, and are there the available resources to implement the mitigation plans.
External Response: How well the local community can provide emergency response, mutual aid, staff and supplies

In an embodiment, a CVR administrator may determine the impact of a threat, how vulnerable a site is to the threat, and the overall severity of the threat. Through a series of gates and assigned weighting factors, the CVR administrator assigns and record a value in a database, evaluate the assigned vulnerability value assigned by the Potential Threat Identification embodiment, and assigns a Severity value for each asset and subsequently, the entire site.

### Criticality Rating Assignment

In an embodiment, a CVR administrator may evaluate any or all of the previously identified factors and weighted values to generate a criticality score. Through a series of gates and assigned weighting factors, the CVR administrator may assign and record a value in a database, evaluates the assigned criticality value assigned by the previous factors, and assigns a Criticality value for each asset and subsequently, the entire site.

### Vulnerability Rating

In an embodiment, a CVR administrator may conduct a vulnerability assessment of a site and, as necessary, each of its identified assets. In certain embodiments, the system may use a comprehensive vulnerability assessment model that derives and assigns an overall vulnerability score. A two dimensional Cartesian coordinate grid may be used to analyze and represent this function, where the “Vulnerability” is represented on the x-axis and the degree of “Loss” resulting from the vulnerabilities is represented on the y-axis. The range for Vulnerability is “Low” on the left side to “High” on the right. The range for Loss is “Low” at the bottom to “High” at the top.

Vulnerability may take into consideration such issues as 1) Physical Security, 2) Operational Security (How information is handled and protected), 3) Cyber Security, 4) Personnel Assurance (Measurement of ethics/honesty/dependability/reliability), 5) Personnel Protection, 6) Emergency Response (Readiness and ability to respond).

Loss may take into consideration such issues as 1) Denials of Service, 2) Delays of Service, 3) Disruption of Service, 4) Disclosure of proprietary information, 5) Direct Loss (property, facilities, equipment, etc.), 6) Financial and Economic impact, 7) Recovery Losses (related to reconstitution of assets), 8) Reputations, 9) Health and Safety (Loss of life or injury), and 10) Environmental Impact.

### Terrorist View

In an embodiment, a CVR administrator may prompt users to respond and input information that can be used to further evaluate the importance of a site to terrorists. In one embodiment, a user interface for such a system may be referred to as a “Terrorist View.” This element may factors in information from the point of view of a terrorist who desires to cause harm to any site. The Terrorist View factors may include, but are not limited to the following:
Masses: Will the terrorist act kill, injure, or at the minimum, inconvenience large numbers of people?
Terrorist Impact: Will the terrorist act provide long-term with lasting effects?
Economic Impact: Will the act significantly impact the target's economy?
Political Statement: Will the act send a significant political statement?
Difficulty: Is the act simple in nature requiring the working around of only a few deterrent systems or does it require complex equipment, technology, or rely on breakdown of multiple systems to be completed?
Resources Required: Does the act require few financial resources or are large amounts of money to execute the act?
Ease of Access: Can the terrorists obtain easy access, such as to a darn or farm, or does it require the complex covert operations?
Terrorist Timing: Can the act be researched, planned and executed in a relatively short amount of time or is there a significant research and preparation required?
Dry Run: Is a practice run required on smaller scale to rehearse act (such as placing a bomb in a Spanish subway) or is it a one time hit or miss effort?
Religious Impact: Is there religious significance to the act?
New Approach: Is the potential terrorism utilize a new method or concept that has probably not been considered and likely not to have deterrents in place—such as using lasers to blind pilots during final approaches?

In an embodiment, a CVR administrator may evaluate the users' input relative to one or more of the above considerations. Through a series of gates and assigned weighting factors, the CVR administrator may assign and record a value in a database, evaluate the responses and assign a Terrorist View value for each asset and subsequently, an entire site.

### Determine Risk Level

In an embodiment, the CVR administrator may, through a series of gates and assigned weighting factors, calculate and assign a Risk value for each asset and subsequently, the entire site. In one embodiment, with the detailed analysis described within this method and apparatus, the CVR administrator may identify and rank 1) What threats represent the greatest risk to a particular asset, and 2) Which assets are at the highest overall risk.

### Corrective Actions

In some embodiments, a comprehensive assessment may be used ion the identification of corrective actions required to reduce the risk and vulnerability of a site and its assets. In an embodiment, a CVR administrator, through a series of gates and assigned weighting factors, may calculate and determine if a corrective actions portion of the assessment is to be administrated to the site.

### Mitigation/Protection Plans

In some embodiments, the result of this comprehensive assessment may be used in the identification of Mitigation/Protection Plans for reducing the risk and vulnerability of a site and its assets. In an embodiment, a CVR administrator, through a series of gates and assigned weighting factors, may calculate and determine if a Mitigation/Protection Plans portion of the assessment is to be administrated to the site.

In an embodiment, a CVR administrator may present a user with a series of questions to capture and identify necessary improvements, recoveries issues, reconstitution and restoration of the site and/or its assets in the following areas: 1) Inside the Fence, 2) Outside the Fence, and 3) Continuity of Operations.

In an embodiment, a CVR administrator may evaluate the users' input relative to the above considerations. Through a series of gates and assigned weighting factors, the CVR administrator may assign and record a value in a database, evaluate the responses and assign to the Mitigation/Protection Plans value for each asset, and subsequently, the entire site. As required, reports can be generated from the database providing a detailed plan for how to improve the site.

### Cost Benefit Analysis

In an embodiment, a CVR administrator may perform an analysis function based upon the cost values stored by the system during an Asset Valuation phase of the assessment. It is common that a site may have multiple Assets. As stated previously, the described system can assess a singular site, or when further granularity is required, each additional asset identified by the site. In some embodiments, the formula set forth below may be used for both site valuation and individual assets.

In one embodiment, a formula to determine Asset Valuation (K) includes two components: 1) Human Resources (H_{R}) and 2) Physical Resources (P_{R}) (brick and mortar and every else other than human resources). The two components are each calculated independently and then added together. This provides the ability to evaluate each component on its own merit and may be especially helpful for valuating sites where the cost of technology becomes a significant factor of the total valuation. The Asset Valuation formula is:

K=H_{R}+P_{R}

The Human Resource (H_{R}) includes two components: Number of Lives Lost (N_{L}) and the Number of Injuries (N_{I}). Two corresponding variables that must be used are the Cost Per Life (C_{PL}) and the Cost Per Injury (C_{PI}). The formula for calculating V_{L} (Value of Life) component is:

H_{R}=((N_{L}×C_{PL})+(N_{I}×C_{PI}))

For the following example, assume:
N_{L}=10 (number of lives lost)
N_{I}=30 (number of injuries)
C_{PL}=$2,700,000 (cost per life)
C_{PI}=$1,000,000 (cost per injury)

The calculation for determining the Human Resource (H_{R}) component is:

H_{R}=((N_{L}×C_{PL})+(N_{I}×C_{PI}))

H_{R}=((10×$2,700,000)+(30×$1,000,000))

H_{R}=(($27,000,000)+($30,000000))

H_{R}=$57,000,000

H_{R}=$57,000,000 (value of the human resource portion of asset)

The Physical Resource (P_{R}) component takes into consideration the Cost of Initial Asset (C_{I}), the Cost of a Temporary Substitute (C_{T}), the Cost of Permanent Replacement (C_{P}), and the cost of Systems Related to the Asset (C_{R}). The formula for calculating the Physical Resource (P_{R}) component is:

P_{R}=(C_{I}+C_{T}+C_{P}+C_{R})

For the following example, assume:
C₁=$10,000,000 (cost of initial asset)
C_{T}=$4,000,000 (cost of temporary substitute)
C_{P}=$5,000,000 (cost of permanent replacement)
C_{R}=$6,000,000 (cost of systems related to asset)

P_{R}=(C_{I}+C_{T}+C_{P}+C_{R})

P_{R}=($10,000,000+$4,000,000+$5,000,000+$6,000,000)

P_{R}=($25,000,000)

P_{R}=$25,000,000

For this example, the total valuation of the site would be determined as follows:

K=+P_{R}

K=$57,000,000+$25,000,000

K=$82,000,000

A common situation that may arise is where, for a site having multiple identified assets, the total additive cost of all the lives and the physical resources exceeds the true maximum cost if the site were lost in a catastrophic event. In an embodiment, a CVR administrator may identify assets, both human and physical, that are shared and common in the asset valuation analysis. For example, during the assessment phase, the system determines the maximum total value of the above referenced site, with its 40 total employees, is $150 million dollars. If the previous example represented one of two assets identified at this site, each similar in value, the combined asset value could not exceed the total value of the site. For example, if Asset1+Asset2 value equals $164,000,000, and the maximum Value of site: $150,000,000, the maximum potential value of all assets combined cannot exceed $150,000,000.

### Overall Analysis

In an embodiment, a CVR administrator may perform a calculation on each of the factors assessed by the CVR administrator and determine the appropriate composite values and scores for each. Through a series of calculations, the CVR administrator may process records in a database and generate any of various types of resultant score for each site. The following is one such calculation determine overall Risk of a site:

Risk=((Asset Value+Criticality+Threat+Vulnerability+Probability)−(Counter Measures+(Continuity of Operations+Mitigation)))

### Examples of Criteria

The following are examples of criteria that may be used in making assessments using the methods and apparatus described herein.

Major Topics

Personnel
Facilities
Equipment/Material
Emergency, Disasters & Attacks
Communications
Management Controls
Operational Controls
Technical Controls
Infrastructure Dependencies
Mission Critical Flow

Sub Topics

Armed Assault on Facilities
Audit Trails
Authorized Processing (Cert. and Accreditation)
Biological or Chemical Attacks
Bombs/Explosive Attacks
Broken Glass Hazard
Business Continuity Planning
Communications Infrastructure Data Network Disruption
Communications Infrastructure Telephone Network Disruption
Communications Infrastructure Wireless Network Disruption
Company Vehicles
Confidentiality Policy
Contingency Planning
Critical Infrastructures
Cyber Assets: Communications
Cyber Assets: Management Controls
Cyber Assets: Operational Controls
Cyber Assets: Technical Controls
Cyber Risk Management
Data Integrity
Disaster Avoidance
Documentation
Emergency Back-up Power
Emergency Planning
Emergency Planning Compliance
Emergency Preparedness - Management Responsibilities
Emergency Preparedness - Site
Emergency Preparedness - Training
Employee Access
Employee Security Issues
Energy Dependencies
Energy Infrastructure Electricity Disruption
Energy Infrastructure Natural Gas Disruption
Energy Infrastructure POL Disruption
Energy Infrastructure Water Disruption
Fire Safety/Incendiary Attack or Emergency
Fire Safety Compliance
General Security
Hardware and System Software Maintenance
Hazardous Materials
HAZMAT Compliance
HAZMAT Emergencies
Identification and Authentication
Incident Response Capability
Information Systems and Communications
Infrastructure Dependencies
Life Cycle
Likelihood of Disaster
Logical Access Controls
Loss of Communications
Mail Handling
Management Succession Plan
Mission Critical Flow
Natural Disasters
Parking Security
Personal Attacks
Personnel Security
Petro-Chemical Security Threats
Physical and Environmental Protection
Physical Assets: Emergency, Disasters & Attacks
Physical Assets: Equipment/Material
Physical Assets: Facilities
Production Input/Output Controls
Protection Rings
Review of Security Controls
Risk Management Analysis
Safeguarding Equipment
Safeguarding Materiel
Security Awareness, Training and Education
Security Program
Sensitive Information
Shut Down of Operations
Site Information
Sourcing of Critical Components
Surge Capacity
Surveillance
System Security Plan
Telecommunications Security Planning
Transportation/Facility Access
Transportation Infrastructure Airport Disruption
Transportation Infrastructure Port Disruption
Transportation Infrastructure Railway Disruption
Transportation Infrastructure Roadway Disruption
Unauthorized Access Security Issues
Utility Management Compliance
Utility Oversight
Visitor Access Security Issues
Warning System
Wireless Communications
Worker Productivity

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method of using a computer system to assess risk, comprising:
identifying one or more critical assets;
identifying at least one vulnerability of the one or more critical assets related to critical path dependencies on commercial infrastructure;
establishing a supply chain dependency and supporting infrastructure that depict critical nodes and links in a critical path;
performing an analysis of at least one key node and determining threats to one or more commercial assets, vulnerabilities, and impacts of disruption;
identifying and determining at least one business process within a dependency chain that may be at risk; and
recommending at least one mitigation option or remediation action to assist decision making with one or more corrective actions.

2. A method of using a computer system to assess risk, comprising:
prompting a user to enter data relating to one or more sites;
collecting the data on the computer system; and
assessing a risk with respect to at least one of the sites using the collected data.

3. The method of claim 2, wherein assessing a risk with respect to at least one of the sites comprises:
identifying a site;
identifying one or more assets at the site;
performing a valuation of one or more assets at the site;
identifying one or more potential threats to the site; and
determining a risk level based on the potential threats.

4. The method of claim 3, wherein at least one of the potential threats is a terrorist threat.

5. The method of claim 2, wherein assessing a risk comprises:
identifying and ranking which of a plurality of threats represents the greatest risk to a particular asset; and
identifying and ranking which assets are at a highest overall risk.

6. The method of claim 2, further comprising qualifying the site, wherein qualifying the site comprises determining an impact to the government if the site were lost.

7. The method of claim 2, further comprising determining whether a risk is acceptable or unacceptable.

8. The method of claim 2, further comprising determining at least one countermeasure to reduce a risk to an acceptable level.

9. The method of claim 2, wherein assessing a risk comprises assigning a criticality vector and a vulnerability vector, wherein the criticality vector and vulnerability vector are used to represent a site's overall risk.

10. The method of claim 2, wherein assessing a risk comprises assigning a criticality vector and a vulnerability vector, wherein the criticality vector and vulnerability vector are used to prioritize or rank a site relative to other sites.

11. The method of claim 2, further comprising determining whether the site is a defense industrial base supplier.

12. The method of claim 2, wherein assessing a risk with respect to at least one of the sites comprises computing a criticality rating.

13. The method of claim 2, wherein assessing a risk with respect to at least one of the sites comprises computing a vulnerability rating.

14. The method of claim 2, wherein assessing a risk with respect to at least one of the sites comprises using variables selected from the group consisting of probability, forewarning, onset speed, exposure, and duration.

15. The method of claim 2, further comprising identifying at least one interdependency relative to the site.

16. The method of claim 2, further comprising identifying at least one corrective action to take relative to the risk.

17. The method of claim 2, further comprising producing a mitigation/protection plan for the site.

18. The method of claim 2, further comprising performing a cost/benefit analysis based on the assessment of risk.

19. The method of claim 2, further comprising scheduling at least one event relating to an assessment of risk.

20. The method of claim 2, further comprising scheduling at least one event relating to assessment of at least two sites.

21. The method of claim 2, further comprising scheduling at least one event relating to assessment of at least two sites, wherein the event is scheduled by an administrative organization, wherein the two sites are managed by a customer of the administrative organization.

22. The method of claim 2, wherein assessing a risk with respect to at least one of the sites comprises determining a ratio of the number of product/service suppliers and the number of critical infrastructure suppliers per level.

23. The method of claim 2, wherein assessing a risk with respect to at least one of the sites comprises determining a single point failure.

24. The method of claim 2, further comprising developing scenarios using artificial intelligence relating to a risk assessment, and presenting the scenarios to a user.

25. The method of claim 2, further comprising qualifying at least one asset, wherein qualifying the at least one asset comprises representing loss on one axis of a Cartesian coordinate grid and criticality on the other axis of the Cartesian coordinate grid.

26. The method of claim 2, wherein the site includes one or more assets, wherein the assets are part of a commercial assets supply chain.

27. An apparatus configured to gather information about an organizational process or system comprising a computer system, the computer system comprising:
a display device configured to display computer driven questions;
an input device configured to transfer inputs from an assessor;
a memory and a processing unit; and
wherein the apparatus is configured to:
prompt a user to enter data relating to one or more sites;
collect the data; and
assess a risk with respect to at least one of the sites using the collected data.

28. A computer readable medium configured to store a set of instructions which:
prompt a user to enter data relating to one or more sites;
collect the data; and
assess a risk with respect to at least one of the sites using the collected data.

29. A method of assessing risk for a customer, comprising:
storing a list of sites for a customer in a memory of a computer system;
providing at least two of the sites with remote access to the computer system;
receiving risk assessment data from the sites via remote access;
automatically performing a risk assessment of the sites using the risk assessment data; and
providing the customer with at least a portion of the risk assessment.

30. The method of claim 29, wherein automatically performing a risk assessment comprises assessing criticality of at least one of the sites.

31. The method of claim 29, wherein automatically performing a risk assessment comprises assessing a vulnerability of at least one of the sites.

32. The method of claim 29, wherein the risk assessment comprises a risk assessment of cyber security.

33. The method of claim 29, wherein the risk assessment comprises a risk assessment of physical security.

34. The method of claim 29, wherein the risk assessment comprises assessing a risk assessment of a business enterprise.

35. The method of claim 29, wherein automatically performing a risk assessment comprises identifying at least one critical path dependency of one of the sites.

36. The method of claim 29, wherein the sites comprise Defense Industrial Base (DIB) sites.

37. The method of claim 29, wherein the sites are organized into two or more blocks.

38. The method of claim 37, wherein at least one of the blocks requires two or more levels of assessment.

39. The method of claim 37, wherein at least one of the blocks requires two or more levels of assessment, the method further comprising scheduling an event for each level of assessment.

40. The method of claim 29, wherein receiving risk assessment data from the sites comprises managing at least one event, wherein the event comprises receiving risk assessment data from at least two of the sites within a scheduled time period.

41. The method of claim 40, further comprising updating a prioritized list of assets assessed for the customer at the close of each event.

42. The method of claim 29, further comprising automatically generating a prioritized list of assets assessed for the customer.

43. The method of claim 29, further comprising the customer notifying each site that the site must provide risk assessment data for the risk assessment.

44. The method of claim 29, wherein providing the customer with at least a portion of the risk assessment comprises allowing the customer to access a viewing utility.

45. The method of claim 29, wherein providing the customer with at least a portion of the risk assessment comprises allowing the customer to remotely access a viewing utility.

46. The method of claim 29, wherein providing the customer with at least a portion of the risk assessment comprises allowing the customer to select from at least two preprogrammed queries or sort methodologies.

47. The method of claim 29, wherein providing the customer with at least a portion of the risk assessment comprises allowing the customer to view data transferred during the assessment.

48. The method of claim 29, wherein providing the customer with at least a portion of the risk assessment comprises providing the customer with a terrorist view of at least a portion of the risk assessment data.

49. The method of claim 29, further comprising providing help desk assistance to at least one of the sites.

50. The method of claim 29, wherein the remote access is web-based.

51. The method of claim 29, further comprising displaying at least one question relating to the risk assessment at one or more of the sites.

52. The method of claim 29, further comprising the computer system remotely displaying at least one question at one or more of the sites.

53. The method of claim 29, wherein the list is an electronic list.

54. The method of claim 29, further comprising providing the customer with at least one corrective action.

55. A computer system, comprising:
a processing unit;
a memory coupled to the processing unit;
the computer system configured to:
receive a list of at least two sites from a customer;
store the list of sites in a memory of a computer,
provide at least two of the sites with remote access to the computer;
receive risk assessment data from the sites via remote access;
automatically perform a risk assessment of the sites using the risk assessment data; and
provide the customer with at least a portion of the risk assessment.

56. The computer system of claim 55, wherein the sites are Defense Industrial Base (DIB) sites.

57. The computer system of claim 55, further comprising an event manager configured to automatically schedule and manage at least one event.

58. The computer system of claim 55, further comprising an event manager configured to manage receiving the assessment data from at least one of the sites.

59. The computer system of claim 55, further comprising a notification system configured to notify personnel of an assessment timeline.

60. The computer system of claim 55, further comprising a critical infrastructure/vulnerability module.

61. A computer readable medium comprising program instructions, the program instructions configured to implement:
receiving a list of at least two sites from a customer,
storing the list of sites in a memory of a computer system;
providing at least two of the sites with remote access to the computer system;
receiving risk assessment data from the sites via remote access;
automatically performing a risk assessment of the sites using the risk assessment data; and
providing the customer with at least a portion of the risk assessment.
